(19) United States
(12) Patent Application Publication
(10) Pub. No.: US 2025/0068029 A1
(43) Pub. Date: Feb. 27, 2025

(54) SOLID CRYSTAL BASED SPATIAL LIGHT MODULATOR

(71) Applicant: Meta Platforms Technologies, LLC, Menlo Park, CA (US)

(72) Inventors: Renate Eva Klementine LANDIG, Kirkland, WA (US); Zhimin SHI, Bellevue, WA (US); Tingling RAO, Bellevue, WA (US); Andrew John OUDERKIRK, Kirkland, WA (US)

(21) Appl. No.: 18/778,890

(22) Filed: Jul. 19, 2024

Related U.S. Application Data
(60) Provisional application No. 63/578,617, filed on Aug. 24, 2023.

(51) Int. Cl. G02F 1/29; G02F 1/015

(52) U.S. Cl. CPC G02F 1/292; G02F 1/0151; G02F 2201/123; G02F 2203/12

(57) ABSTRACT

A device is disclosed. The device includes an organic solid crystal. The device also includes a pixel electrode layer and a common electrode layer coupled with the organic solid crystal, the pixel electrode layer including an array of pixel electrodes. The device also includes a controller configured to individually configure voltages applied to the pixel electrodes to individually configure local refractive indices of the organic solid crystal.

### CROSS REFERENCE TO RELATED APPLICATION

This application claims the benefit of priority to U.S. Provisional Application No. 63/578,617, filed on Aug. 24, 2023. The content of the above-referenced application is incorporated by reference in its entirety.

### TECHNICAL FIELD

The present disclosure relates generally to optical devices and, more specifically, to a solid crystal based spatial light modulator.

### BACKGROUND

Holography uses light interference patterns to form three-dimensional (“3D”) images. A traditional hologram is a holographic interference pattern of a signal light beam from a real object and a reference light beam from a coherent light source. Computer-generated holography applies various algorithms to simulate the holographic interference patterns generated by traditional holography. A computer-generated hologram may be presented by using a spatial light modulator (“SLM”) to encode a pattern output by such an algorithm into a light beam emitted from a light source.

An SLM may impose a spatially varying modulation of either the amplitude or the phase on a light beam. Computer-generated holography may impose modulations on multiple degrees of freedom (“DOFs”) of a light beam, such as both of the amplitude and the phase. One conventional approach for modulating multiple DOFs of a light beam may involve using an optical relay-imaging assembly, which may image the plane of a first SLM that modulates a first DOF of a light beam to the plane of a second SLM that modulates a second DOF of the light beam. Another conventional approach for modulating multiple DOFs of a light beam may involve laminating together multiple SLMs that modulate different DOFs.

### SUMMARY OF THE DISCLOSURE

One aspect of the present disclosure provides a device. The device includes an organic solid crystal. The device also includes a pixel electrode layer and a common electrode layer coupled with the organic solid crystal, the pixel electrode layer including an array of pixel electrodes. The device also includes a controller configured to individually configure voltages applied to the pixel electrodes to individually configure local refractive indices of the organic solid crystal.

Another aspect of the present disclosure provides a device. The device includes one or more patterned organic solid crystals arranged in a thickness direction of the device. A patterned organic solid crystal of the one or more patterned organic solid crystals includes an array of solid crystal segments arranged within a plane perpendicular to the thickness direction of the device. A solid crystal segment of the array of solid crystal segments is coupled with a source electrode, a drain electrode, a gate electrode, and an insulator disposed between the gate electrode and the solid crystal segment. The device also includes a controller configured to individually configure voltages applied to the solid crystal segments to individually configure refractive indices of the solid crystal segments.

Other aspects of the present disclosure can be understood by those skilled in the art in light of the description, the claims, and the drawings of the present disclosure.

### BRIEF DESCRIPTION OF THE DRAWINGS

The following drawings are provided for illustrative purposes according to various aspects of the present disclosure, and are not intended to limit the scope of the present disclosure.

In the drawings:

FIGS. 1A and 1B illustrates schematic diagrams of solid crystal based spatial light modulators (“SLMs”), according to one or more examples of the present disclosure;

FIGS. 2A-2D illustrate schematic diagrams of solid crystal based SLMs, according to one or more examples of the present disclosure;

FIGS. 3A and 3B illustrate schematic diagrams of solid crystal based SLMs, according to one or more examples of the present disclosure;

FIG. 4A illustrates a schematic diagram of a solid crystal based SLM, according to one or more examples of the present disclosure;

FIG. 4B illustrates a schematic diagram of a solid crystal based SLM, according to one or more examples of the present disclosure;

FIG. 5 illustrates a schematic diagram of a solid crystal based SLM, according to one or more examples of the present disclosure;

FIGS. 6A-6I illustrate example chemical structures of various molecules of solid crystal materials, according to one or more examples of the present disclosure;

FIG. 7 illustrates a schematic diagram of an optical system including a solid crystal based SLM, according to one or more examples of the present disclosure;

FIG. 8 illustrates a schematic diagram of an optical system including a solid crystal based SLM, according to one or more examples of the present disclosure;

FIG. 9 illustrates a schematic diagram of an optical system including a solid crystal based SLM, according to one or more examples of the present disclosure;

FIG. 10A illustrates a schematic diagram of an artificial reality device, according to one or more examples of the present disclosure; and

FIG. 10B schematically illustrates a cross-sectional view of half of the artificial reality device shown in FIG. 10A, according to one or more examples of the present disclosure.

### DETAILED DESCRIPTION

Various aspects of the present disclosure will be described with reference to the accompanying drawings, which are merely examples for illustrative purposes and are not intended to limit the scope of the present disclosure. Wherever possible, the same reference numbers are used throughout the drawings to refer to the same or similar parts, and a detailed description thereof may be omitted.

Further, in the present disclosure, the disclosed embodiments and the features of the disclosed embodiments may be combined. The described embodiments are some but not all of the embodiments of the present disclosure. Based on the disclosed embodiments, persons of ordinary skill in the art may derive other embodiments consistent with the present disclosure. For example, modifications, adaptations, substitutions, additions, or other variations may be made based on the disclosed embodiments. Such variations of the disclosed embodiments are still within the scope of the present disclosure. Accordingly, the present disclosure is not limited to the disclosed embodiments. Instead, the scope of the present disclosure is defined by the appended claims.

As used herein, the terms “couple,” “coupled,” “coupling,” or the like may encompass an optical coupling, a mechanical coupling, an electrical coupling, an electromagnetic coupling, or a combination thereof. An “optical coupling” between two optical devices refers to a configuration in which the two optical devices are arranged in an optical series, and a light output from one optical device may be directly or indirectly received by the other optical device. An optical series refers to optical positioning of a plurality of optical devices in a light path, such that a light output from one optical device may be transmitted, reflected, diffracted, converted, modified, or otherwise processed or manipulated by one or more of other optical devices. The sequence in which the plurality of optical devices are arranged may or may not affect an overall output of the plurality of optical devices. A coupling may be a direct coupling or an indirect coupling (e.g., coupling through an intermediate element).

The phrase “one or more” may be interpreted as “at least one.” The phrase “at least one of A or B” may encompass various combinations of A and B, such as A only, B only, or A and B. Likewise, the phrase “at least one of A, B, or C” may encompass various combinations of A, B, and C, such as A only, B only, C only, A and B, A and C, B and C, or A and B and C. The phrase “A and/or B” has a meaning similar to that of the phrase “at least one of A or B.” For example, the phrase “A and/or B” may encompass various combinations of A and B, such as A only, B only, or A and B. Likewise, the phrase “A, B, and/or C” has a meaning similar to that of the phrase “at least one of A, B, or C.” For example, the phrase “A, B, and/or C” may encompass various combinations of A, B, and C, such as A only, B only, C only, A and B, A and C, B and C, or A and B and C.

When a first element is described as “attached,” “provided,” “formed,” “affixed,” “mounted,” “secured,” “connected,” “bonded,” “recorded,” or “disposed,” to, on, at, or at least partially in a second element, the first element may be “attached,” “provided,” “formed,” “affixed,” “mounted,” “secured,” “connected,” “bonded,” “recorded,” or “disposed,” to, on, at, or at least partially in the second element using any suitable mechanical or non-mechanical manner, such as depositing, coating, etching, bonding, gluing, screwing, press-fitting, snap-fitting, clamping, etc. In addition, the first element may be in direct contact with the second element, or there may be an intermediate element between the first element and the second element. The first element may be disposed at any suitable side of the second element, such as left, right, front, back, top, or bottom.

When the first element is shown or described as being disposed or arranged “on” the second element, term “on” is merely used to indicate an example relative orientation between the first element and the second element. The description may be based on a reference coordinate system shown in a figure, or may be based on a current view or example configuration shown in a figure. For example, when a view shown in a figure is described, the first element may be described as being disposed “on” the second element. It is understood that the term “on” may not necessarily imply that the first element is over the second element in the vertical, gravitational direction. For example, when the assembly of the first element and the second element is turned 180 degrees, the first element may be “under” the second element (or the second element may be “on” the first element). Thus, it is understood that when a figure shows that the first element is “on” the second element, the configuration is merely an illustrative example. The first element may be disposed or arranged at any suitable orientation relative to the second element (e.g., over or above the second element, below or under the second element, left to the second element, right to the second element, behind the second element, in front of the second element, etc.).

When the first element is described as being disposed “on” the second element, the first element may be directly or indirectly disposed on the second element. The first element being directly disposed on the second element indicates that no additional element is disposed between the first element and the second element. The first element being indirectly disposed on the second element indicates that one or more additional elements are disposed between the first element and the second element.

The wavelength ranges, spectra, or bands mentioned in the present disclosure are for illustrative purposes. The disclosed optical device, system, element, assembly, and method may be applied to a visible wavelength range, as well as other wavelength ranges, such as an ultraviolet (“UV”) wavelength range, an infrared (“IR”) wavelength range, or a combination thereof.

The term “film,” “layer,” “coating,” or “plate” may include rigid or flexible, self-supporting or free-standing film, layer, coating, or plate, which may be disposed on a supporting substrate or between substrates. The terms “film,” “layer,” “coating,” and “plate” may be interchangeable. The phrases “in-plane direction,” “in-plane orientation,” “in-plane rotation,” “in-plane alignment pattern,” and “in-plane pitch” refer to a direction, an orientation, a rotation, an alignment pattern, and a pitch in a plane of a film or a layer (e.g., a surface plane of the film or layer, or a plane parallel to the surface plane of the film or layer), respectively. The term “out-of-plane direction” or “out-of-plane orientation” indicates a direction or an orientation that is non-parallel to the plane of the film or layer (e.g., perpendicular to the surface plane of the film or layer, e.g., perpendicular to a plane parallel to the surface plane). For example, when an “in-plane” direction or orientation refers to a direction or an orientation within a surface plane, an “out-of-plane” direction or orientation may refer to a thickness direction or orientation perpendicular to the surface plane, or a direction or orientation that is not parallel with the surface plane.

The term “processor” used herein may encompass any suitable processor, such as a central processing unit (“CPU”), a graphics processing unit (“GPU”), an application-specific integrated circuit (“ASIC”), a programmable logic device (“PLD”), or any combination thereof. Other processors not listed above may also be used. A processor may be implemented as software, hardware, firmware, or any combination thereof.

The term “controller” may encompass any suitable electrical circuit, software, or processor configured to generate a control signal for controlling a device, a circuit, an optical element, etc. A “controller” may be implemented as software, hardware, firmware, or any combination thereof. For example, a controller may include a processor, or may be included as a part of a processor.

The term “non-transitory computer-readable medium” may encompass any suitable medium for storing, transferring, communicating, broadcasting, or transmitting data, signal, or information. For example, the non-transitory computer-readable medium may include a memory, a hard disk, a magnetic disk, an optical disk, a tape, etc. The memory may include a read-only memory (“ROM”), a random-access memory (“RAM”), a flash memory, etc.

Liquid crystals (“LCs”) have been used as an active medium in spatial light modulators (“SLMs”) for modulating the amplitude or the phase of a light beam. One of the limitations of LC-based SLMs is the slow modulation speed or switching speed. For example, a typical modulation frequency is below 1 kHz, and the typical switching time is at the level of millisecond. The switching speed may be improved by reducing the thickness of the LC layer in the SLM. However, as the thickness of the LC layer reduces, the phase modulation range provided by the LC-based SLM to the light beam may be insufficient. Another limitation of LC-based SLMs is the large pixel size or pixel pitch, which may be, e.g., about 3-10 micrometers. The field of view of an SLM may be inversely proportional to the pixel size, e.g., a smaller pixel size may lead to a larger field of view. However, as the pixel size decreases, the fringing field generated within the LC layer may increase which may, in turn, not only reduce the phase modulation range but also increase the cross-talk between neighboring pixels. Furthermore, the fabrication of LC-based SLMs may be incompatible with monolithic multilayer fabrication. For example, an LC-based SLM may be fabricated by bonding a silicon backplane or thin-film transistor (“TFT”) backplane and a cover plate to form a cell with a predetermined gap, and filling an LC material into the cell. A complex wavefront modulator that modulates both the amplitude and the phase of a light beam may be fabricated by laminating together two LC-based SLMs that respectively modulate the phase and the amplitude. Such a conventional complex wavefront modulator may be bulky and heavy.

In view of the limitations in the conventional technologies, the present disclosure provides a solid crystal based spatial light modulator (“SLM”). The SLM disclosed herein may include one or more solid crystals whose optical properties (e.g., refractive indices, birefringences, and/or absorption characteristics, etc.) may vary with an applied potential (e.g., voltage) through charge injection. Thus, through configuring the local potentials (e.g., voltages) applied to the solid crystal, the local optical properties (e.g., refractive indices, birefringences, and/or absorption characteristics, etc.) may be individually configurable to modulate the local amplitudes and/or local phases of an input light beam. Due to the high refractive index (e.g., 1.5 to 2.6) of the solid crystal, the SLM disclosed herein may be subject to a weaker fringing field than LC-based SLMs and, thus, may be allowed to have smaller pixel sizes (or pixel pitches) than LC-based SLMs. The SLM disclosed herein may provide a faster switching speed (e.g., at the level of microsecond, such as, about 10 microseconds) than LC-based SLMs. The SLM disclosed herein may be fabricated by monolithic growth, which may facilitate more compact multilayer designs, e.g., a complex SLM stack in a 4f configuration.

In the following description, various solid crystal based SLMs will be explained. The solid crystal may be a single crystal or a polycrystal. The solid crystal may include an organic material, an inorganic material, or a combination thereof. For example, the solid crystal may include an organic and crystalline material, an organic and non-crystalline material, an organic and amorphous material, an organic and semi-crystalline and semi-amorphous material, an inorganic and crystalline material, an inorganic and non-crystalline material, an inorganic and amorphous material, an inorganic and semi-crystalline and semi-amorphous material, an organic and semi-crystalline and semi-non-crystalline material, an inorganic and semi-crystalline and semi-non-crystalline material, or a combination thereof. In the present discourse, the solid crystal may not include liquid crystal and polymerized liquid crystal. For discussion purposes, an organic solid crystal material may be used as an example of the solid crystal. For convenience of discussion, solid crystal molecules included in the solid crystal material may also be referred to as organic molecules or crystal molecules. It is understood that the technical solutions disclosed herein are not limited to organic solid crystal materials.

As used herein, an “axis” of a crystal (or solid crystal) may refer to an axis of the solid crystal along which the solid crystal has the highest or largest refractive index. An “axis” of a crystal molecule included in the solid crystal may refer to an axis of the crystal molecule along which the crystal molecule may have the highest or largest refractive index. The axis of the crystal may be an aggregated effect of the axes of the crystal molecules included in the crystal. The orientation of the axis of the solid crystal may be an aggregated effect of the orientations of the axes of crystal molecules in the solid crystal. The above definitions of the axis of the solid crystal and the axis of the crystal molecules are for the convenience of discussion. The orientation of the axis of the solid crystal may also be referred to as a crystal orientation of the solid crystal. The orientations associated with the solid crystal and the crystal molecules are not limited to be defined by the axes along which the refractive index is the highest. Other suitable axes (e.g., axes along which the refractive index is the smallest, or axes perpendicular to the axes along which the refractive index is the highest) may be used as a configurable object for the discussion of the orientation of the solid crystal and the orientations of the crystal molecules, or for the discussion of the alignment pattern associated with the solid crystal or the crystal molecules.

In some examples, the crystal molecules in the solid crystal may be substantially uniformly aligned in a predetermined direction. Alternatively, the crystal molecules in the solid crystal may be substantially non-uniformly aligned in an orientation pattern. In some examples, the solid crystal may be optically isotropic. Alternatively, the solid crystal may be optically anisotropic, for example, uniaxially or biaxially optically anisotropic. In some examples, the solid crystal may have a first principal refractive index along a first direction, and a second principal refractive index along a second direction perpendicular to the first direction. The first direction may be parallel to the axis of the solid crystal along which the solid crystal may have the highest or largest refractive index. The first principal refractive index of the solid crystal may be in a range of 1.5 to 2.6. For example, the first principal refractive index of the solid crystal may be at least about 1.5, at least about 1.6, at least about 1.7, at least about 1.8, at least about 1.9, at least about 2.0, at least about 2.1, or at least about 2.2. In some examples, an optical anisotropy (e.g., a difference between the first principal refractive index and the second principal refractive index) of the solid crystal may be at least about 0.1, at least about 0.2, at least about 0.3, at least about 0.35, or at least about 0.4.

The solid crystal may be in a form of a layer, a film, or a plate. Due to the high refractive index of the solid crystal (e.g., about 1.5 to 2.6), the solid crystal may be made thin and light weight. For example, the solid crystal may have a thickness of about 500 nanometer (“nm”) to about 5 micrometer (“μm”). Accordingly, the disclosed SLMs fabricated based on the solid crystal may be made thin, light weight, and compact. Solid crystal materials have been used to fabricate semiconductor elements or devices with limited small sizes. For example, conventional semiconductor elements or devices fabricated using organic solid crystal materials may have a size of about 10 millimeter (“mm”) by 10 mm or less. The technical solution disclosed in the present disclosure enables fabrication of solid crystals having a large size. For example, by forming (e.g., growing) a solid crystal using an alignment structure, the solid crystal may be fabricated to have one or more lateral dimensions of about 30-100 mm or greater. Solid crystals having such large sizes may widen the applications of optical devices in a wide variety of technical fields.

In some examples, the solid crystal may be fabricated based on one or more solid crystal materials, such as anthracene, tetracene, pentacene or any other saturated or unsaturated polycyclic hydrocarbons and their derivatives; nitrogen, sulfur and oxygen heterocycles; quinolines, benzothiophenes, and benzopyrans; bent and asymmetric acenes such as phenanthrene, phenanthroline, pyrene, and fluoranthene and their derivatives; 2,6-naphthalene dicarboxylic acid, 2,6-dimethyl carboxylic ester molecules and their derivatives; biphenyl, terphenyl, quaterphenyl, or phenylacetylene, or their derivatives including substitutes with alkyl groups, cyano groups, isothiocyanate groups, fluorine, chlorine or fluorinated ether; polycyclic aromatic hydrocarbons, such as naphthalene, anthracene, tetracene, pentacene, pyrene, polycene, fluoranthene, benzophenone, benzochromene, benzil, benzimidazole, benzene, hexachlorobenzene, nitropyridine-N-oxide, benzene-1, 4-dicarboxylic acid, diphenylacetylene, N-(4-nitrophenyl)-(s)-prolinal, 4,5-dicyanoimidazole, benzodithiophene, cyanopyridine, thienothiophene, stilbene, azobenzene, or their derivatives.

In some examples, the solid crystal material may include one or more of the following molecules. One or more (e.g., each) of these molecules may include a ring structure (or a ring structure system) and two terminal groups (or terminal group systems). The ring structure may include one or more saturated cyclic groups, such as cyclohexane, cyclopentane, tetrahydropyran, piperidine, tetrahydrofuran, pyrrolidine, tetrahydrothiophene, or their derivatives. In some examples, the ring structure may include one or more unsaturated aromatic groups, such as benzene, naphthalene, anthracene, thiophene, bi-phenyl, tolane, benzimidazole, diphenylacetylene, cyanopyridine, thienothiophene, dibenzothiophene, carbazole, silafluorene, or their derivatives. The terminal group may include one or more C₁-C₁₀ alkyl, alkoxy, alkenyl groups, —CN, —NCS, —SCN, —SF₅, —Br, —Cl, —F, —OCF₃, —CF₃, mono- or polyfluorinated C₁-C₁₀ alkyl or alkoxy group.

In some examples, the solid crystal material may include crystalline polymers. Precursors of the crystalline polymers may include aromatic hydrocarbon or heteroarene groups, and their derivatives. Examples of the crystalline polymers may include polyethylene naphthalate, poly (vinyl phenyl sulfide), poly(a-methylstyrene, polythienothiophene, polythiophene, poly(n-vinylphtalimide), parylene, polysulfide, polysulfone, or poly(bromophenyl), poly(vinlynaphthalene).

In some examples, the solid crystal material may include amorphous polymers with aliphatic, hetroaliphatic, aromatic hydrocarbon or heteroarene groups (e.g., polystyrene) as binder. In some examples, the solid crystal material may also include additives, such as fatty acid, lipids, plasticizer, or surfactant (e.g., molecules with mono- or polyfluorinated alkyl or alkoxy group).

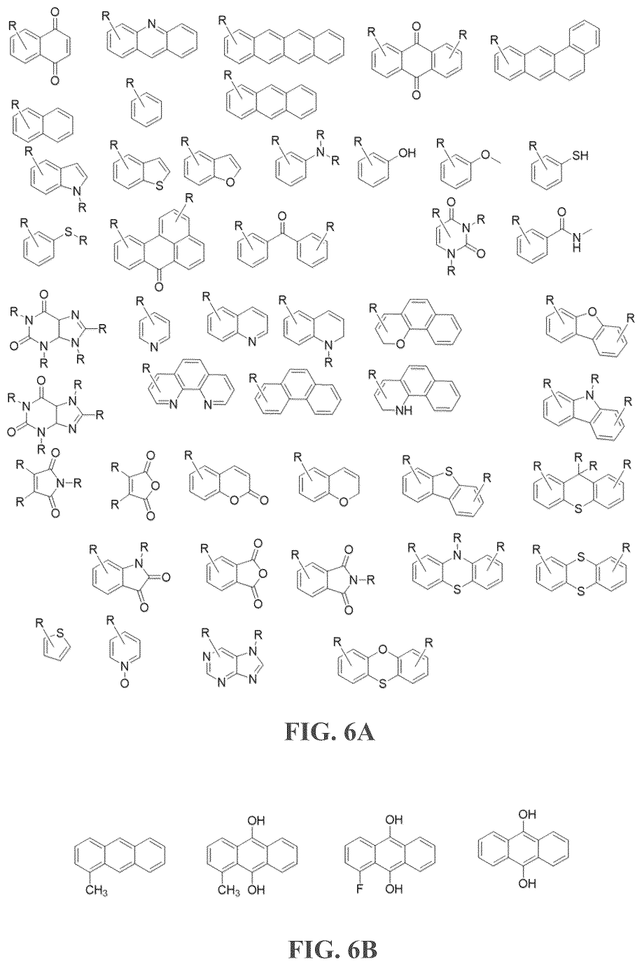

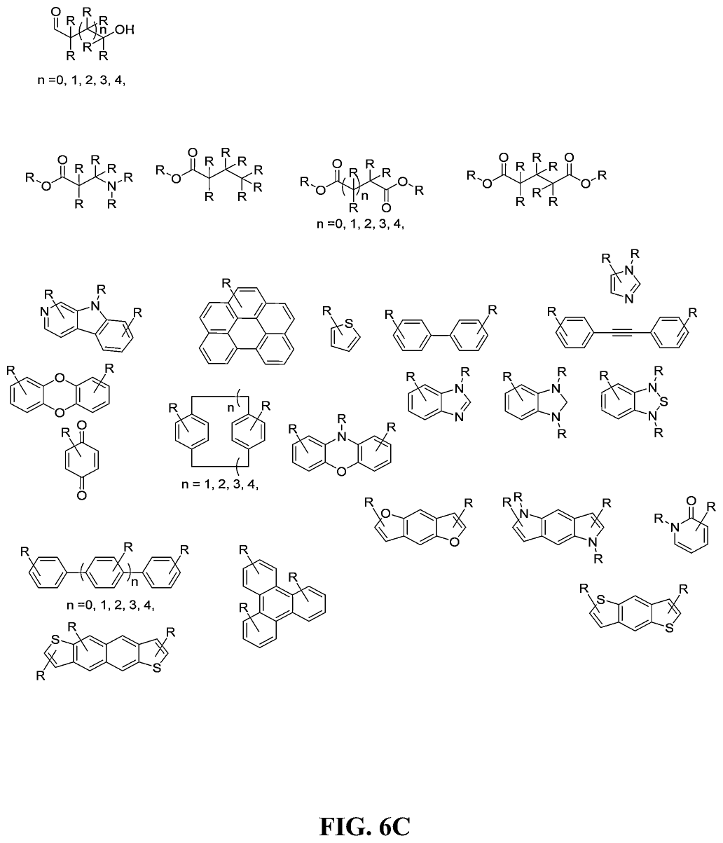

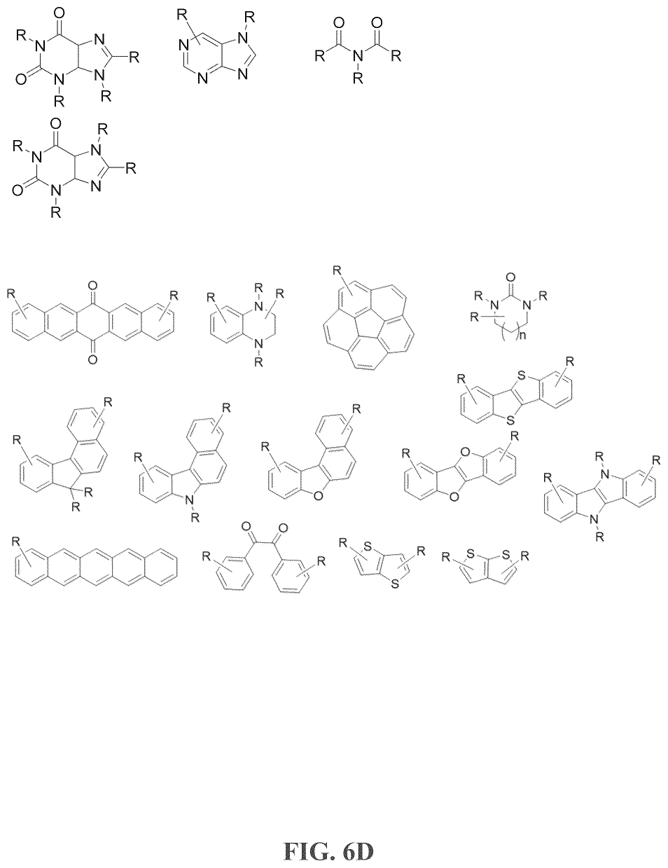

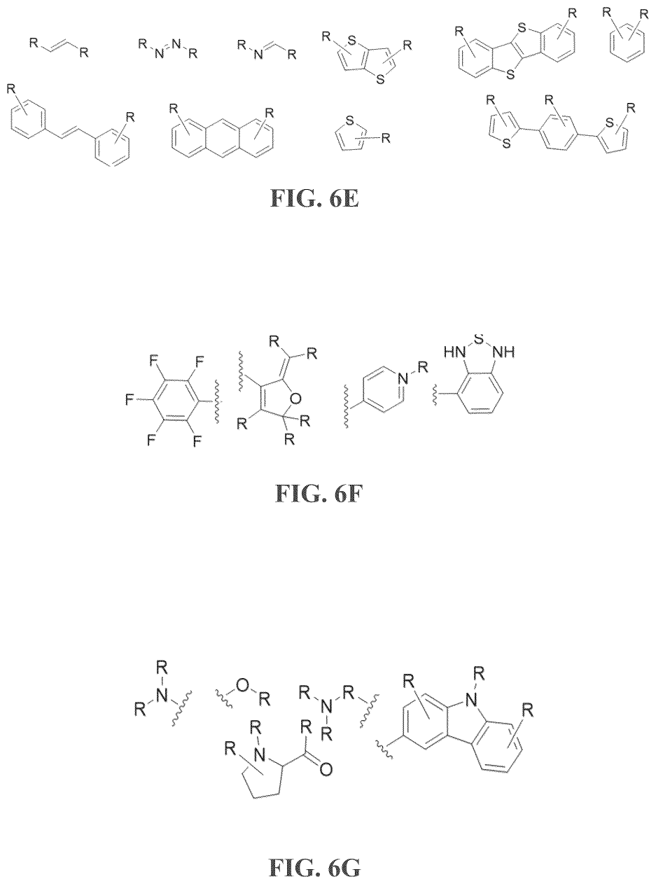

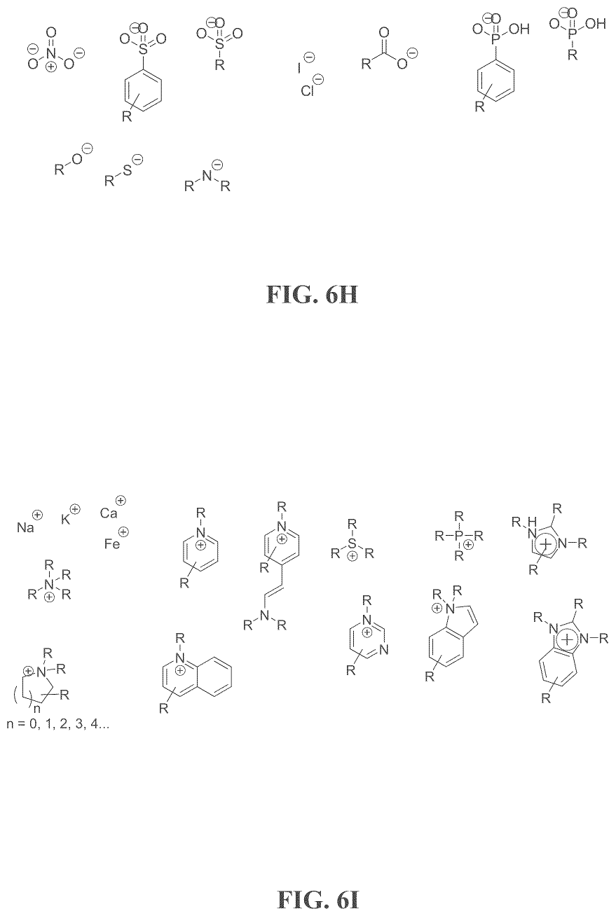

FIG. 6A illustrates example chemical structures of various molecules that may be included in the solid crystal material. In the chemical structures, R is a functional group, which may be any one or any combination of CH₃, H, OH, OMe, OEt, OiPr, F, Cl, Br, I, Ph, NO₂, SO₃, SO₂Me, iPr, Pr, t-Bu, sec-Bu, Et, acetyl, SH, SMe, carboxyl, aldehyde, amide, nitrile, ester, SO₂NH₃, NH₂, NMe₂, NMeH, or C₂H₂. For example, when a chemical formula includes two or more Rs, all of the Rs may be different, all of the Rs may be the same, at least two Rs may be different, or at least two Rs may be the same. FIG. 6B illustrates example chemical structures of molecules that include one or a combination of the functional groups R listed above and shown in FIG. 6A.

In some examples, the solid crystal material may include sugars or fatty acids. FIG. 6C illustrates chemical structures of various sugars and fatty acids that may be included in the solid crystal material. The functional group R may be any of CH₃, H, OH, OMe, OEt, OiPr, F, Cl, Br, I, Ph, NO₂, SO₃, SO₂Me, iPr, Pr, t-Bu, sec-Bu, Et, acetyl, SH, SMe, carboxyl, aldehyde, amide, nitrile, ester, SO₂NH₃, NH₂, NMe₂, NMeH, or C₂H₂. The molecules shown in FIG. 6C may include any one or any combination of the listed functional groups R.

FIG. 6D illustrates example chemical structures of molecules that may be included in the solid crystal material. A molecule may include one or a combination of the above functional groups R, i.e., any one or any combination of CH₃, H, OH, OMe, OEt, OiPr, F, Cl, Br, I, Ph, NO₂, SO₃, SO₂Me, iPr, Pr, t-Bu, sec-Bu, Et, acetyl, SH, SMe, carboxyl, aldehyde, amide, nitrile, ester, SO₂NH₃, NH₂, NMe₂, NMeH, or C₂H₂.

In some examples, the molecules that may be included in the solid crystal material may have a donor-bridge-acceptor molecular motif, a donor-bridge-donor molecular motif, or an acceptor-bridge-acceptor molecular motif. FIG. 6E illustrates example bridge functional groups that may be included in the molecules. FIG. 6F illustrates example electron withdrawing groups (acceptor groups) that may be included in the molecules. FIG. 6G illustrates example electron donating groups (donor groups) that may be included in the molecules. In some examples, a molecule may include one or a combination of the above functional groups R, i.e., any one or any combination of CH₃, H, OH, OMe, OEt, OiPr, F, Cl, Br, I, Ph, NO₂, SO₃, SO₂Me, iPr, Pr, t-Bu, sec-Bu, Et, acetyl, SH, SMe, carboxyl, aldehyde, amide, nitrile, ester, SO₂NH₃, NH₂, NMe₂, NMeH, or C₂H₂.

In some examples, the solid crystal material may include organo-salts, a mix of anionic and cationic molecules with one or more organic based components. FIG. 6H illustrates example chemical structures of Anionic molecules that may be included in the solid crystal material. FIG. 6I illustrates example chemical structures of cationic molecules. The functional group R may be any one or any combination of CH₃, H, OH, OMe, OEt, OiPr, F, Cl, Br, I, Ph, NO₂, SO₃, SO₂Me, iPr, Pr, t-Bu, sec-Bu, Et, acetyl, SH, SMe, carboxyl, aldehyde, amide, nitrile, ester, SO₂NH₃, NH₂, NMe₂, NMeH, or C₂H₂. In some examples, the functional group R may also include a mix of electron donating and electron withdrawing functions shown in FIG. 6F and FIG. 6G.

The SLMs disclosed herein may be configured to modulate a degree of freedom (“DOF”), such as an amplitude, a phase, or a polarization of an input light beam. The SLM disclosed herein may be a complex wavefront modulator configured to modulate at least two DOFs of the input light beam, such as both the amplitude and the phase of the input light beam. The SLM disclosed herein may operate at one or more of a transmissive mode, a reflective mode, a transflective mode, or a resonate mode. The SLMs disclosed herein may be configured to modulate a DOF of the input light beam. In some examples, the SLM disclosed herein may be a bistable SLM, which is switchable between a first operation state providing a first optical modulation to the input light beam and a second operation state providing a second, different optical modulation to the input light beam.

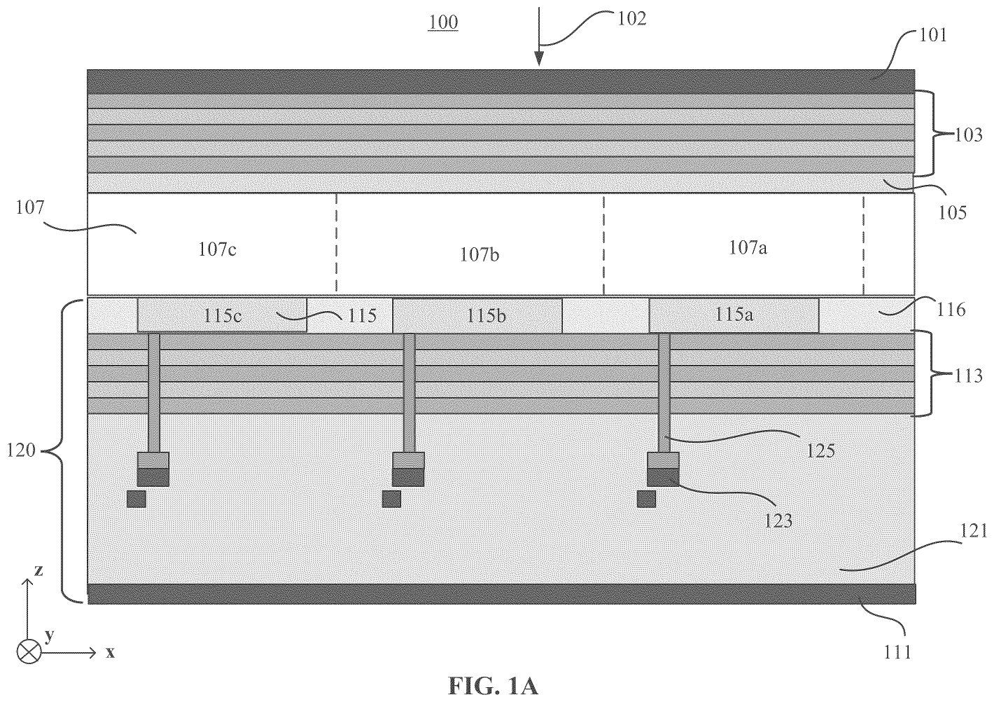

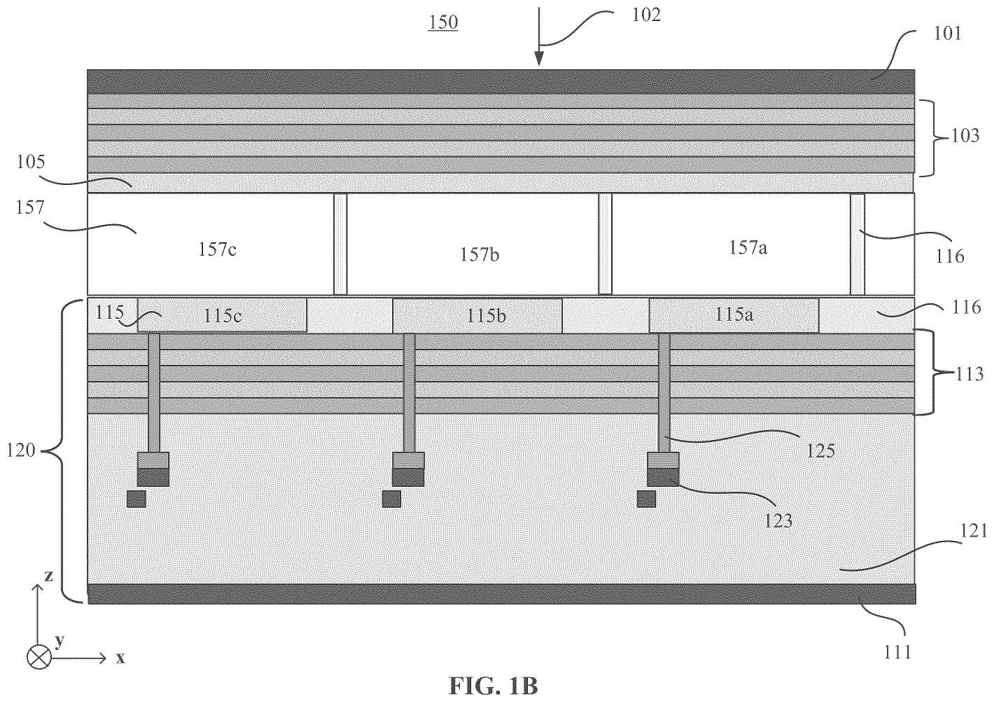

FIG. 1A illustrates an x-z sectional view of an organic solid crystal based spatial light modulator (“SLM”) 100, according to one or more examples of the present disclosure. As shown in FIG. 1A, the SLM 100 may include a first polarizer 101, a first coating 103, a first electrode layer 105, an organic solid crystal 107 (e.g., 107a, 107b, 107c), and a backplane 120. The first coating 103 may be disposed between the first polarizer 101 and the first electrode layer 105. The first polarizer 101, the first coating 103, and the first electrode layer 105 may be disposed at a first side of the organic solid crystal 107. The backplane 120 may be disposed at a second side of the organic solid crystal 107 opposing to the first side. As shown in FIG. 1A, the backplane 120 may include a base substrate 121, an electric circuitry 123, a plurality of conducting vias 125, a second electrode layer 115 (e.g., 115a, 115b, 115c), a second coating 113, and a second polarizer 111. The second coating 113 may be disposed between the base substrate 121 and the second electrode layer 115. The base substrate 121 may be disposed between the second polarizer 111 and the second coating 113. The organic solid crystal 107 may be disposed between the first electrode layer 105 and the second electrode layer 115.

In some examples, the first polarizer 101 or the second polarizer 111 may be a linear polarizer or a circular polarizer. The first polarizer 101 or the second polarizer 111 may be an absorptive type polarizer configured to substantially transmit a polarized light having a predetermined polarization, and substantially block, via absorption, a polarized light having a polarization that is orthogonal to the predetermined polarization. In some examples, the first polarizer 101 or the second polarizer 111 may be reflective polarizer configured to substantially transmit a polarized light having a predetermined polarization, and substantially reflect a polarized light having a polarization that is orthogonal to the predetermined polarization.

The first polarizer 101 or the second polarizer 111 may include any suitable polarizer, such as a wire-grid element, an LC-based polarization-selective element, an interference-based thin-film-stack element, or a sub-wavelength grating structure, a metamaterial structure, etc. In some examples, the second polarizer 111 may be omitted. For example, the SLM 100 may be a reflective SLM in which the backplane 120 may be a silicon backplane, and the SLM 100 may include the first polarizer 101 and may not include the second polarizer 111. In some examples, the SLM 100 may be a transmissive SLM in which the backplane 120 may be a transmissive thin-film transistor (“TFT”) backplane, and the SLM 100 may include both the first polarizer 101 and the second polarizer 111.

The base substrate 121 may provide support and protection to various layers, films, and/or structures formed thereon. In some examples, the base substrate 121 may be a wafer, a glass, a plastic substrate, a sapphire, or a combination thereof, etc. In some examples, the base substrate 121 may be rigid, semi-rigid, flexible, or semi-flexible. In some examples, the base substrate 121 may include a flat surface or a curved surface, on which the various layers, films, and/or structures may be formed. In some examples, the base substrate 121 may be a part of another element or device (e.g., another opto-electrical element or device, another electrical element or device). In some examples, the electric circuitry 123 (a portion is shown in this cross-sectional view) may be at least partially embedded in the base substrate 121, and may be electrically connected to the second electrode layer 115 through the conducting vias 125.

In some examples, the first coating 103 or the second coating 113 may include a plurality of layers stacked together, one or more (e.g., each) of which may include a dielectric material, a metallic material, a semiconductor material, or a combination thereof. In some examples, the first coating 103 or the second coating 113 may also include one or more layers of nano-composite materials, nano-structured materials, organic solid crystals, or metamaterials with feature sizes comparable with or smaller than an operation wavelength of the SLM 100.

In some examples, one or more (e.g., each) of the first coating 103 and the second coating 113 may include an anti-reflection layer, such that the input light beam 102 may have a single pass through the organic solid crystal 107, and the SLM 100 may operate at a transmissive mode. In some examples, one of the first coating 103 and the second coating 113 may include an anti-reflection layer, and the other of the first coating 103 and the second coating 113 may include a high-reflection layer, such that the input light beam 102 may have double passes through the organic solid crystal 107, and the SLM 100 may operate at a reflective mode. For example, the first coating 103 may include an anti-reflection layer and the second coating 113 may include a high-reflection layer, such that the first coating 103 may substantially transmit the input light beam 102, the second coating 113 may substantially reflect the input light beam 102, and the input light beam 102 may propagate through the organic solid crystal 107 twice. In some examples, one of the first coating 103 and the second coating 113 may include a partial-reflection layer, and the other of the first coating 103 and the second coating 113 may include a partial-reflection or high-reflection layer, such that the input light beam 102 may have multiple passes (more than two) through the organic solid crystal 107, and the SLM 100 may operate at a resonant mode. In some examples, one of the first coating 103 and the second coating 113 may be an active reflective coating with a tunable reflection efficiency, such that the SLM 100 may be switchable between operating at an in-resonance state and at an out-of-resonance state. In some examples, one or more (e.g., each) of the first coating 103 and the second coating 113 may be an active reflective coating with a tunable reflection efficiency.

In some examples, one or both of the first electrode layer 105 and the second electrode layer 115 may include a suitable material configured to build up a potential therebetween. The material included in the first electrode layer 105 or the second electrode layer 115 may also be configured to facilitate a current injection into the organic solid crystal 107. For example, the first electrode layer 105 or the second electrode layer 115 may include a suitable electrically conductive material, such as a transparent conductive oxide material (e.g., indium tin oxide (“ITO”), aluminum zinc oxide (“AZO”), etc.), a metal material (e.g., with high reflectivity), structured metal grids, a conducting polymer, a dielectric-metal-dielectric (“DMD”) structure, carbon nanotubes, silver nanowires, semiconductor (e.g., n-type semiconductor or p-type semiconductor), or a combination thereof.

The first electrode layer 105 may function as a common electrode layer applied with a common voltage (e.g., ground). For example, the first electrode layer 105 may be a single contiguous electrode layer, or a pixelated or patterned electrode layer including a plurality of pixelated electrodes that are applied with the same common voltage. The second electrode layer 115 may function as a pixel electrode layer, which may be a pixelated or patterned electrode layer including a plurality of separate, individual pixel electrodes 115a-115c. Although three pixel electrodes 115a-115c are shown for illustrative purposes, any suitable number of pixel electrodes may be included in the second electrode layer 115. One or more (e.g., each) of the pixel electrodes 115a-115c may be individually and independently controlled by a controller (not shown). For example, the controller may control a power source (not shown) to supply different or the same voltages to the plurality of individual pixel electrodes 115a-115c. The controller may be any suitable controller, and may include a processor, a memory for storing processor-executable instructions. The controller may include hardware components such as physical circuits and/or software components.

The pixel electrodes 115a-115c may be separated from one another by an insulator (or an insulator layer) 116. The insulator 116 may include a suitable dielectric material, e.g., an organic compound (e.g., a polymer), an inorganic compound (e.g., a silicon dioxide), or a combination thereof.

As shown in FIG. 1A, the organic solid crystal 107 may be a contiguous layer across substantially the entire SLM 100. The substantially entire organic solid crystal 107 may be virtually divided into a plurality of solid crystal portions (or solid crystal segments) 107a-107c corresponding to the plurality of pixels (also referred to as pixels 107a-107c), respectively. The SLM 100 may include a plurality of pixels (e.g., three pixels as shown in FIG. 1A) that are individually (or independently) configurable to modulate the local amplitudes or local phases of the input light beam 102. In some examples, one or more (e.g., each) of the pixels may include a pixel electrode 115a, 115b, or 115c, a solid crystal portion or segment 107a, 107b, or 107c, and the associated portions of the first electrode layer 105, the first coating 103, the second coating 113, the first polarizer 101, and the second polarizer 111. The size of the pixel may be configured to be less than 100 m, less than 10 m, or less than 1 m.

In some examples, the organic solid crystal 107 may be a patterned layer rather than a contiguous layer. FIG. 1B illustrates an x-z sectional view of an organic solid crystal based SLM 150, according to one or more examples of the present disclosure. The organic solid crystal based SLM 150 shown in FIG. 1B may include structures or elements that are the same as or similar to those included in the organic solid crystal based SLM 100 shown in FIG. 1A. Descriptions of the same or similar structures or elements included in the example shown in FIG. 1B can refer to the above descriptions, including those rendered in connection with the example shown in FIG. 1A. As shown in FIG. 1B, the organic solid crystal based SLM 150 may include a patterned organic solid crystal 157. The patterned organic solid crystal 157 may include a plurality of solid crystal segments 157a-157c corresponding to the plurality of pixels 127a-127c, respectively. The solid crystal segments 157a-157c of the organic solid crystal 157 may be separated from one another by the insulator 116.

Referring back to FIG. 1A, the organic solid crystal 107 may be in direct contact with both the first electrode layer (e.g., common electrode layer) 105 and the second electrode layer (e.g., pixel electrode layer) 115. When a voltage is applied between the first electrode layer 105 and the second electrode layer 115, a vertical electric field in the thickness direction of the organic solid crystal 107 (e.g., a z-axis direction in FIG. 1A) may be generated within the organic solid crystal 107, and an electric current may flow through the organic solid crystal 107. The refractive index of the organic solid crystal 107 may vary with the intensity of the electric field generated within the organic solid crystal 107. The birefringence of the organic solid crystal 107 may vary with the intensity of the electric field generated within the organic solid crystal 107. The birefringence change of the organic solid crystal 107 may result in a polarization state change in the input light beam 102 after the input light beam 102 passes through the organic solid crystal 107. Thus, the polarization state of the input light beam 102 exiting (or propagating through) the organic solid crystal 107 may vary with the intensity of the electric field generated within the organic solid crystal 107. The absorption characteristics of the organic solid crystal 107 for the input light beam (e.g., visible light beam) 102 may vary with the intensity of the electric field generated within the organic solid crystal 107.

In some examples, both the first electrode layer 105 and the second electrode layer 115 may include suitable electrically conductive materials other than semiconductor, and the organic solid crystal 107 coupled with the first electrode layer 105 and the second electrode layer 115 may function as a resistive type device. In some examples, one of the first electrode layer 105 and the second electrode layer 115 may include a suitable electrically conductive material other than semiconductor, and the other of the first electrode layer 105 and the second electrode layer 115 may include a suitable n-type semiconductor or p-type semiconductor. The organic solid crystal 107 coupled with the first electrode layer 105 and the second electrode layer 115 may function as a Schottky p-n junction type device (or Schottky diode).

During an operation of the SLM 100, the first electrode layer 105 may be applied with a uniform voltage (e.g., may be grounded), the voltages applied to the respective pixel electrodes 115a-115c may be individually (or independently) configured. Thus, local electric field intensities within the organic solid crystal 107 (or the electric field intensities within the virtually divided organic solid crystal segments 107a-107c) may be individually configurable to modulate the local refractive indices, the local birefringences, and/or local absorption characteristics of the organic solid crystal 107. For example, through configuring the local electric field intensities within the organic solid crystal 107, the local refractive indices of the organic solid crystal 107 may be individually configurable to modulate the local amplitudes and/or local phases of the input light beam 102. In some examples, through configuring the local electric field intensities within the organic solid crystal 107, the local birefringences of the organic solid crystal 107 may be individually configurable to modulate the local amplitudes and/or local phases of the input light beam 102. In some examples, through configuring the local electric field intensities within the organic solid crystal 107, the local absorption characteristics of the organic solid crystal 107 for the input light beam 102 (e.g., a visible light beam) may be individually configurable to modulate the local amplitudes of the input light beam 102.

In some examples, an individual pixel electrode or pixel may be addressed using its individual conducting via 125, for example, an N×N array of pixels may need an N² number of conducting vias 125. In some examples, an individual pixel electrode or pixel may be addressed using a row/column addressing scheme to reduce the number of the conducting vias 125. For example, the number of the conducting vias 125 used for the N×N array of pixels may be reduced to 2*N.

The SLM 100 may be fabricated by monolithic growth. For example, the backplane 120 may be fabricated via suitable fabrication techniques. The organic solid crystal 107 may be fabricated (e.g., grown) on the backplane 120, and the first electrode layer 105, the first coating 103, and the first polarizer 101 may be successively fabricated on the organic solid crystal 107.

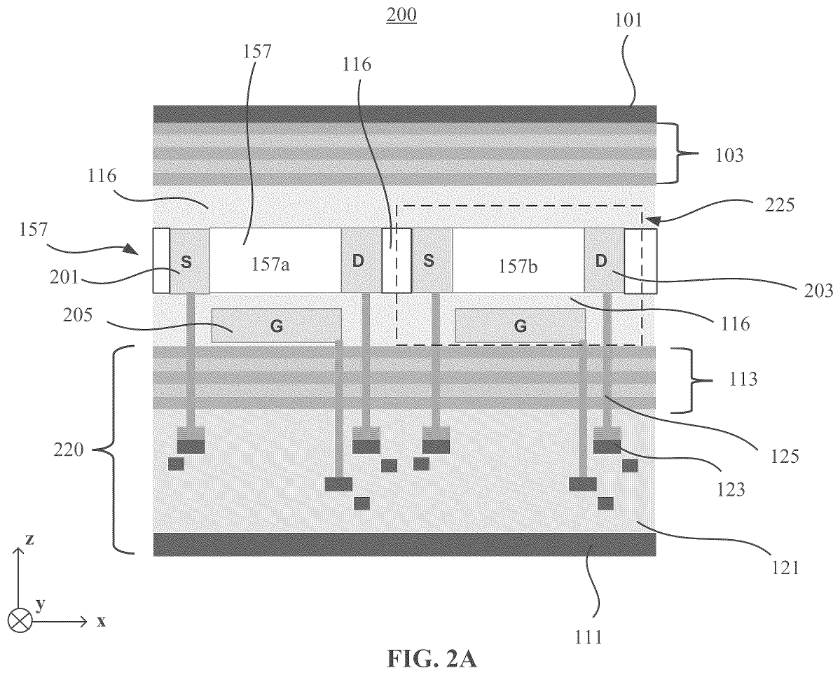

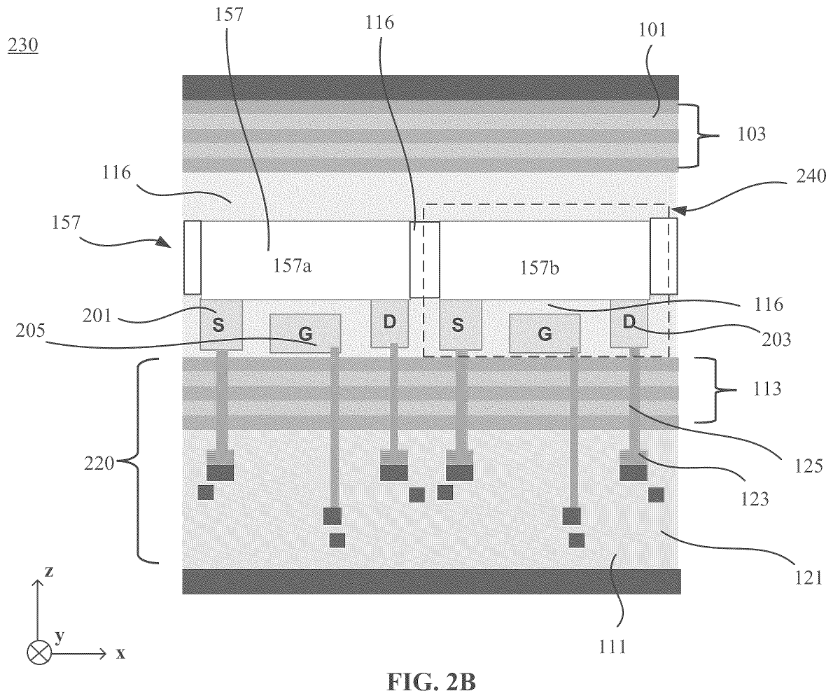

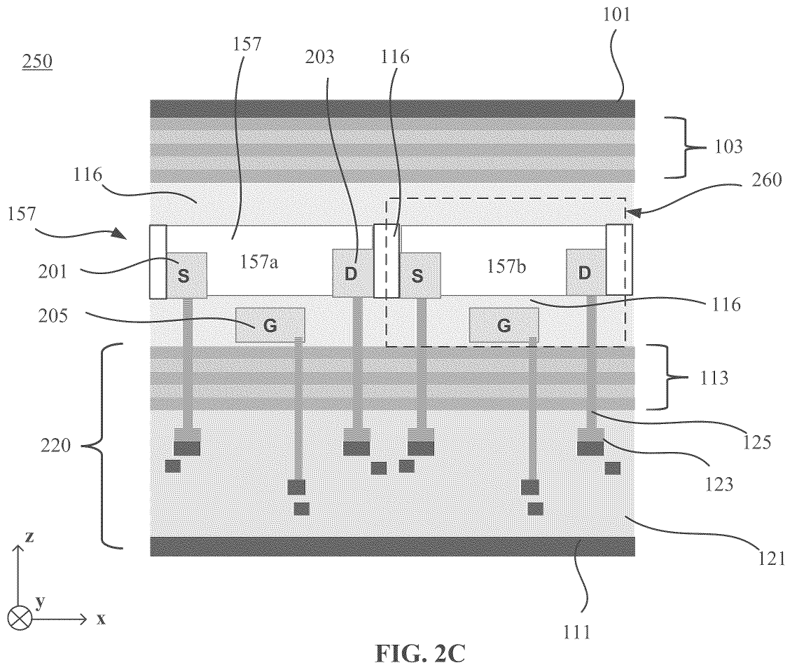

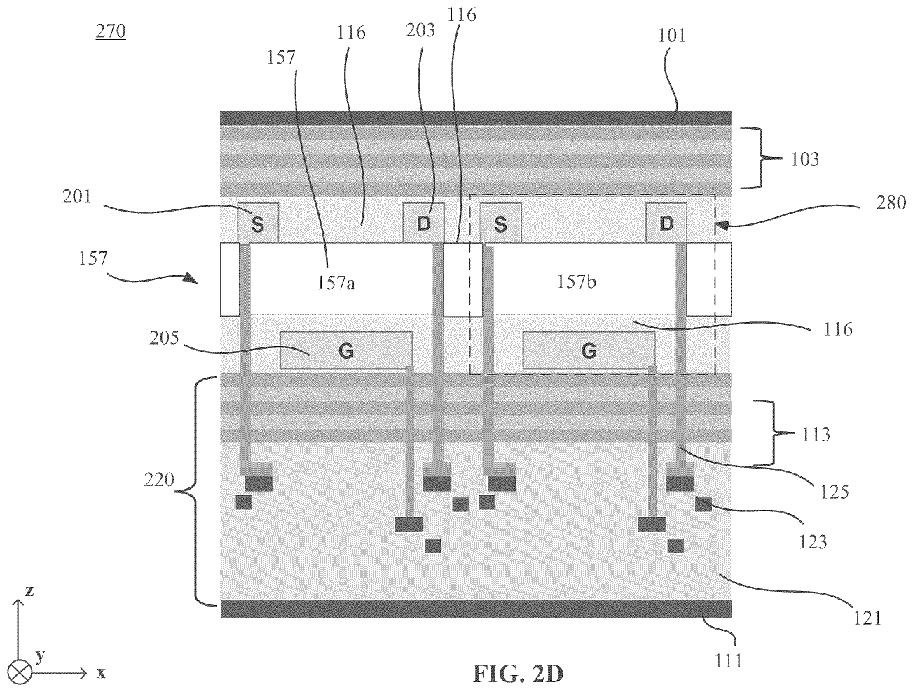

FIGS. 2A-2D illustrate x-z sectional views of organic solid crystal based SLMs, according to one or more examples of the present disclosure. The organic solid crystal based SLMs shown in FIGS. 2A-2D may include structures or elements that are the same as or similar to those included in the organic solid crystal based SLM 100 shown in FIG. 1A, or the organic solid crystal based SLM 150 shown in FIG. 1B. Descriptions of the same or similar structures or elements included in the examples shown in FIGS. 2A-2D can refer to the above descriptions, including those rendered in connection with the example shown in FIG. 1A or FIG. 1B.

As shown in FIG. 2A, an organic solid crystal based SLM 200 may include the first polarizer 101, the first coating 103, a backplane 220, and the patterned organic solid crystal 157 disposed between the first coating 103 and the backplane 220. The first coating 103 may be disposed between the first polarizer 101 and the patterned organic solid crystal 157. The backplane 220 may include the base substrate 121, the electric circuitry 123, the conducting vias 125, the second coating 113, and the second polarizer 111. The second coating 113 may be disposed between the base substrate 121 and the patterned organic solid crystal 157. The base substrate 121 may be disposed between the second polarizer 111 and the second coating 113. The patterned organic solid crystal 157 may be disposed between the first coating 103 and the second coating 113. The patterned organic solid crystal 157 may include a plurality of organic solid crystal segments 157a and 157b.

The organic solid crystal based SLM 200 may include an array of organic field-effect transistors (“OFETs”) 225 disposed between the first coating 103 and the second coating 113. One or more (e.g., each) of the OFETs 225 may include the organic solid crystal segment 157a or 157b, a source electrode (S) 201, a drain electrode (D) 203, and a gate electrode (G) 205, and the insulator 116 disposed between the gate electrode 205 and the organic solid crystal segment 157a or 157b. The insulator 116 disposed between the gate electrode (G) 205 and the organic solid crystal segment 157a or 157b may also be referred to as a gate insulator 116. The organic solid crystal segment 157a or 157b may be disposed between the source electrode (S) 201 and the drain electrode (D) 203. The source electrode (S) 201, the drain electrode (D) 203, and the gate electrode (G) 205 may be coupled with the organic solid crystal segments 157a and 157b. The adjacent OFETs 225 may be separated from one another by the insulator 116.

In some examples, one or more (e.g., each) of the OFETs 225 may also include a charge transport layer (not shown) that is disposed between the source electrode (S) 201 and the organic solid crystal segment 157a or 157b, and/or a charge transport layer (not shown) that is disposed between the drain electrode (D) 203 and the organic solid crystal segment 157a or 157b. In some examples, the charge transport layer may include an organic compound (e.g., carbon nanotubes), an inorganic compound, or a combination thereof. In some examples, the insulator 116 may also be disposed between one or more (e.g., each) of the OFETs 225 and the first coating 103, and/or between one or more (e.g., each) of the OFETs 225 and the second coating 113.

The operation of an OFET 225 may rely on a gate-source voltage applied between the gate electrode (G) 205 and the source electrode (S) 201, and a drain-source voltage applied between the drain electrode (D) 203 and the source electrode (S) 201. When the gate-source voltage is higher than a threshold voltage of the OFET 225, charges may be accumulated an interface between the gate insulator 116 and the organic solid crystal segment 157a or 157b located between the drain electrode (D) 203 and the gate electrode (G) 205. The drain-source voltage may force the accumulated charges to flow from the source electrode (S) 201 to the drain electrode (D) 203. The charge density in the transistor channel and, thus, the current flowing through the transistor channel may be modulated by the magnitude of the gate-source voltage.

In some examples, during an operation of the SLM 200, the drain-source voltages of the respective OFETs 225 may be substantially the same. For example, the source electrodes (S) 201 of the respective OFETs 225 may be applied with a uniform voltage (e.g., grounded). The drain electrodes (D) 203 of the respective OFETs 225 may be applied with a uniform voltage (e.g., a non-zero voltage). The voltages applied to the gate electrodes (G) 205 of the respective OFETs 225 may be individually (or independently) configured, i.e., the gate-source voltages of the respective OFETs 225 may be individually (or independently) configured. Thus, the refractive indices, the birefringence, and/or the absorption characteristics of the respective OFETs 225 may be individually configurable to modulate the local amplitudes and/or local phases of the input light beam 102.

For convenience of discussion, the z-axis direction shown in FIG. 2A is referred to as the thickness direction, and the x-axis direction is referred to as a lateral direction, which is perpendicular to the thickness direction. The organic solid crystal segment 157a or 157b may have a first side (e.g., a top side) facing the first coating 103, and an opposing second side (e.g., a bottom side) facing the second coating 113. The first side and the second side are along the thickness direction of the SLM 200, or along the thickness direction of the organic solid crystal segment 157a or 157b. The organic solid crystal segment 157a or 157b may also have a third side (e.g., a left side) and an opposing fourth side (e.g., a right side) arranged in the lateral direction of the organic solid crystal segment 157a or 157b. The positions of the source electrode (S) 201, the drain electrode (D) 203, and the gate electrode (G) 205 with respect to the organic solid crystal segment 157a or 157b may be configured in various ways.

As shown in FIG. 2A, the organic solid crystal segment 157a or 157b may be disposed over the gate electrodes (G) 205. For example, the gate electrodes (G) 205 may be disposed at the second side (e.g., bottom side) of the organic solid crystal segment 157a or 157b. The source electrode (S) 201 and the drain electrode (D) 203 may be disposed at the third side (left side) and the fourth side (right side) of the organic solid crystal segment 157a or 157b. In some examples, the backplane 220 may also include the gate electrode (“G”) 205 and the insulator 116 disposed between the gate electrode 205 and the organic solid crystal segment 157a or 157b.

In some examples, the gate electrode (“G”) 205 may be configured to be a reflective electrode, and the organic solid crystal based SLM 200 may function as a reflective SLM, in which the second polarizer 111 may be omitted. In some examples, the gate electrode (“G”) 205 may be configured to be a transmissive electrode, and the organic solid crystal based SLM 200 may function as a transmissive SLM, in which the second polarizer 111 may be included.

As shown in FIG. 2B, an organic solid crystal based SLM 230 may include an array of OFETs 240 disposed between the first coating 103 and the second coating 113. The organic solid crystal segment 157a or 157b may be disposed over the gate electrodes (G) 205, the source electrode (S) 201, and the drain electrode (D) 203, with the insulator 116 disposed between the gate electrodes (G) 205 and the organic solid crystal segment 157a or 157b. For example, the gate electrodes (G) 205, the source electrode (S) 201, and the drain electrode (D) 203 may be disposed at the second side (e.g., bottom side) of the organic solid crystal segment 157a or 157b. In some examples, the backplane 220 may also include the gate electrode (“G”) 205, the source electrode (S) 201, the drain electrode (D) 203, and the insulator 116 disposed between the gate electrode 205 and the organic solid crystal segment 157a or 157b.

As shown in FIG. 2C, an organic solid crystal based SLM 250 may include an array of OFETs 260 disposed between the first coating 103 and the second coating 113. The organic solid crystal segment 157a or 157b may be disposed over the gate electrodes (G) 205, with the insulator 116 disposed between the gate electrodes (G) 205 and the organic solid crystal segment 157a or 157b. For example, the gate electrodes (G) 205 may be disposed at the second side (e.g., bottom side) of the organic solid crystal segment 157a or 157b. The source electrode (S) 201 and the drain electrode (D) 203 may be at least partially disposed inside the organic solid crystal segment 157a or 157b. For discussion purposes, FIG. 2C shows that substantially the entire source electrode (S) 201 and substantially the entire drain electrode (D) 203 are disposed inside the organic solid crystal segment 157a or 157b at the left and right sides, respectively. In some examples, the backplane 220 may also include the gate electrode (“G”) 205, the source electrode (S) 201, the drain electrode (D) 203, and the insulator 116 disposed between the gate electrode 205 and the organic solid crystal segment 157a or 157b.

As shown in FIG. 2D, an organic solid crystal based SLM 270 may include an array of OFETs 280 disposed between the first coating 103 and the second coating 113. The organic solid crystal segment 157a or 157b may be disposed over the gate electrodes (G) 205, with the insulator 116 disposed between the gate electrodes (G) 205 and the organic solid crystal segment 157a or 157b. For example, the gate electrodes (G) 205 may be disposed at the second side (e.g., bottom side) of the organic solid crystal segment 157a or 157b. The source electrode (S) 201 and the drain electrode (D) 203 may be disposed over the organic solid crystal segment 157a or 157b. For example, the source electrode (S) 201 and the drain electrode (D) 203 may be disposed at the first side (e.g., top side) of the organic solid crystal segment 157a or 157b. The source electrode (S) 201 and the drain electrode (D) 203 may be in contact with the top surface of the organic solid crystal segment 157a or 157b. In some examples, the backplane 220 may also include the gate electrode (“G”) 205, and the insulator 116 disposed between the gate electrode 205 and the organic solid crystal segment 157a or 157b.

The arrangements of the gate electrode (“G”) 205, the source electrode (S) 201, and the drain electrode (D) 203 with respect to the organic solid crystal segment 157a or 157b shown in FIGS. 2A-2D are for illustrative purposes. The gate electrode (“G”) 205, the source electrode (S) 201, and the drain electrode (D) 203 may be configured to be disposed at other suitable locations with respect to the organic solid crystal segment 157a or 157b. For example, the gate electrode (“G”) 205 may be disposed over the organic solid crystal segment 157a or 157b, with the insulator 116 disposed between the gate electrodes (G) 205 and the organic solid crystal segment 157a or 157b.

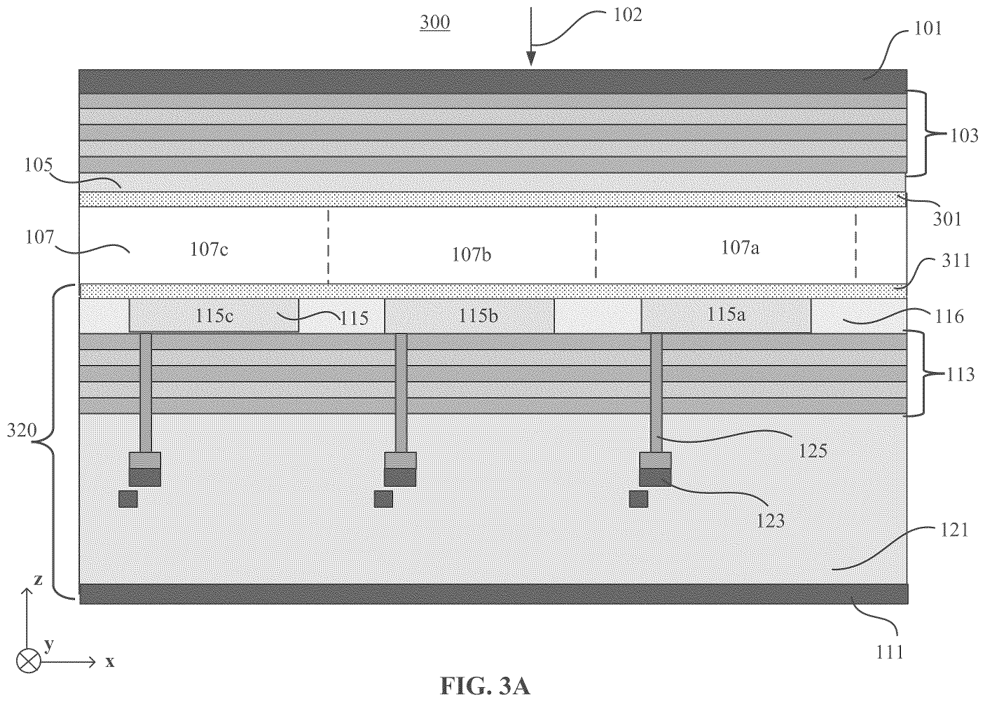

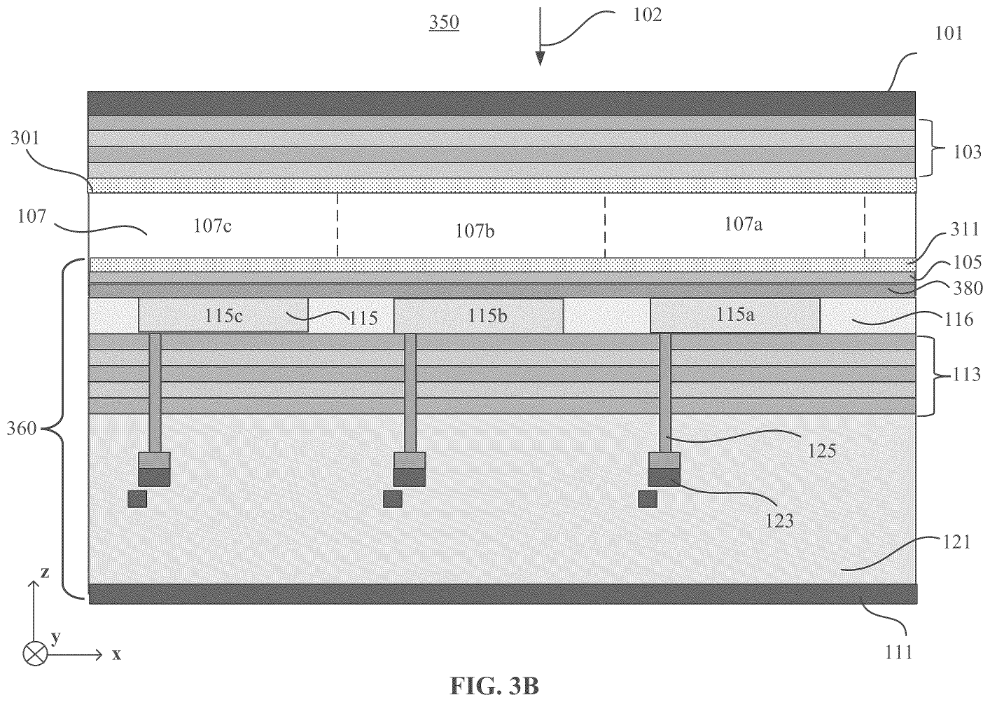

FIG. 3A illustrates an x-z sectional view of the organic solid crystal based SLM 300, according to one or more examples of the present disclosure. FIG. 3B illustrates an x-z sectional view of the organic solid crystal based SLM 350, according to one or more examples of the present disclosure. The organic solid crystal based SLM 300 shown in FIG. 3A and the organic solid crystal based SLM 350 shown in FIG. 3B may include structures or elements that are the same as or similar to those included in the organic solid crystal based SLM 100 shown in FIG. 1A, or the organic solid crystal based SLM 150 shown in FIG. 1B. Descriptions of the same or similar structures or elements included in the examples shown in FIGS. 3A and 3B can refer to the above descriptions, including those rendered in connection with the example shown in FIG. 1A or FIG. 1B.

As shown in FIG. 3A, the SLM 300 may include the first polarizer 101, the first coating 103, the first electrode layer 105, a first spacing layer 301, the organic solid crystal 107, and a backplane 320. The backplane 320 may include a second spacing layer 311, the second electrode layer 115, the base substrate 121, the electric circuitry 123, the conducting vias 125, the second coating 113, and the second polarizer 111. The first coating 103 may be disposed between the first polarizer 101 and the first electrode layer 105. The first electrode layer 105 may be disposed between the first coating 103 and the first spacing layer 301. The first spacing layer 301 may be disposed between the first electrode layer 105 and the organic solid crystal 107.

The second spacing layer 311 may be disposed between the second electrode layer 115 and the organic solid crystal 107. The second electrode layer 115 may be disposed between the second spacing layer 311 and the second coating 113. The second coating 113 may be disposed between the base substrate 121 and the second electrode layer 115. The base substrate 121 may be disposed between the second polarizer 111 and the second coating 113. The organic solid crystal 107 may be disposed between the first electrode layer 105 and the second electrode layer 115.

In some examples, the first spacing layer 301 or the second spacing layer 311 may include a suitable dielectric material, e.g., an organic compound (e.g., a polymer), an inorganic compound (e.g., silicon dioxide), or a combination thereof. In some examples, the first spacing layer 301 or the second spacing layer 311 may include a suitable insulating material. In some examples, the first spacing layer 301 or the second spacing layer 311 may include a semiconductor, e.g., a p-type semiconductor or an n-type semiconductor. In some examples, one or both of the first spacing layer 301 and the second spacing layer 311 may include an alignment structure configured to at least partially align crystal molecules of the organic solid crystal 107 in a predetermined alignment pattern (e.g., a predetermined alignment direction). For example, the orientations of the axes of the crystal molecules that are in contact with the alignment structure may be aligned by (or with) the alignment structure, and the orientations of the axes of remaining crystal molecules in the volume of the organic solid crystal 107 may be aligned according to the neighboring crystal molecules that have been aligned and/or configured by the alignment structure. In some examples, the predetermined alignment pattern of the crystal molecules may result in the spatially uniform (or constant) orientations of the axes of the crystal molecules within the organic solid crystal 107. Accordingly, the axis of the organic solid crystal 107 may be configured to have a constant orientation within the organic solid crystal 107.

In some examples, the alignment structure may be in a form of an alignment film or layer, such as a photoalignment material (“PAM”) layer, a mechanically rubbed polymeric layer, or a polymer layer with anisotropic nanoimprint. In some examples, the alignment structure may be in a form of an alignment film or layer including an anisotropic relief, a ferroelectric or ferromagnetic material, or a crystalline film. For example, the alignment structure may include a photosensitive material (e.g., a photoalignment material), of which the molecules/functional groups may be configured to have an orientational order under polarized light irradiation. In some examples, the alignment structure may include a polymer, of which the polymer chain/functional group may be configured to have an orientational order under mechanical rubbing. In some examples, the alignment structure may include an amorphous polymer configured to induce an orientation order of crystal molecules via a surface interaction between the organic solid crystal and the amorphous polymer. In some examples, the alignment structure may include liquid crystalline, crystalline polymers, or a combination thereof. In some examples, the alignment structure may include an amorphous inorganic material, a crystalline inorganic material, or a combination thereof. In some examples, the alignment structure may include a mixture of the above-mentioned materials.

As shown in FIG. 3A, the first electrode layer 105 and the second electrode layer 115 may be disposed at two opposite sides of the organic solid crystal 107, and may not be in direct contact with the organic solid crystal 107. The first spacing layer 301 and the second spacing layer 311 may be in direct contact with the organic solid crystal 107. The organic solid crystal 107 coupled with the first electrode layer 105, the second electrode layer 115, the first spacing layer 301, and the second spacing layer 311 may function as a capacitive type device. When a voltage is applied between the first electrode layer 105 and the second electrode layer 115, a vertical electric field may be generated within the organic solid crystal 107, while an electric current may not flow through the organic solid crystal 107.

The refractive index of the organic solid crystal 107 may vary with the electric field intensity within the organic solid crystal 107. During an operation of the SLM 300, the first electrode layer 105 may be applied with a uniform voltage, and voltages applied to the respective pixel electrodes 115a-115c may be individually (or independently) configured. Thus, the local refractive indices, the local birefringences, and/or the local absorption characteristics of the organic solid crystal 107 may be individually configurable to modulate the local amplitudes and/or local phases of the input light beam 102.

As shown in FIG. 3B, the first electrode layer 105 and the second electrode layer 115 may be disposed at the same side (e.g., lower side) of the organic solid crystal 107, and an electrically insulating layer 380 may be disposed between the first electrode layer 105 and the second electrode layer 115. In some examples, one of the first spacing layer 301 and the second spacing layer 311 may be omitted. For example, the first spacing layer 301 disposed at the upper side of the organic solid crystal 107 may be omitted. As shown in FIG. 3B, a backplane 360 of the SLM 350 may include the second spacing layer 311, the first electrode layer 105, the electrically insulating layer 380, the second electrode layer 115, the base substrate 121, the electric circuitry 123, the conducting vias 125, the second coating 113, and the second polarizer 111.

When a voltage is applied between the first electrode layer 105 and the second electrode layer 115, a horizontal electric field may be generated within the organic solid crystal 107, while a current may not flow through the organic solid crystal 107. The refractive index of the organic solid crystal 107 may vary with the electric field intensity within the organic solid crystal 107. During an operation of the SLM 350, the first electrode layer 105 may be applied with a uniform voltage, and voltages applied to the respective pixel electrodes 115a-115c may be individually (or independently) configured. Thus, the local refractive indices, the local birefringences, and/or the local absorption characteristics of the organic solid crystal 107 may be individually configurable to modulate the local amplitudes and/or local phases of the input light beam 102.

Referring to FIGS. 3A and 3B, the organic solid crystal 107 is shown as a contiguous layer that may be virtually divided into multiple solid crystal portions (or solid crystal segments) 107a-107c. Although not shown, the SLM 300 shown in FIG. 3A and the SLM 350 shown in FIG. 3B may include a patterned organic solid crystal that includes a plurality of solid crystal segments separated from one another by an insulator, such as the patterned organic solid crystal 157 shown in FIG. 1B.

The SLMs shown in FIGS. 1A-3B may include a single organic solid crystal (e.g., a single layer of contiguous organic solid crystal or a single layer of patterned organic solid crystal) disposed in the thickness direction of the SLM. Such a disclosed SLM may function as a single layer OFET type device, a single layer capacitive type device, or a single layer resistive type device, etc. In some examples, to increase the modulation range, e.g., to provide a 2π phase modulation range for phase modulation or π/2 phase modulation range for amplitude modulation, multiple layers of organic solid crystals may be staked in the thickness direction of the SLM. In some examples, the stack of multiple layers of organic solid crystals may be configured to be polarization dependent. The SLM may function as a multi-layer OFET type device, a multi-layer capacitive type device, a multi-layer resistive type device, or a multi-layer Schottky p-n junction type device, etc. The overall phase retardance provided by the SLM may be a sum of the phase retardances provided by the multiple organic solid crystal layers.

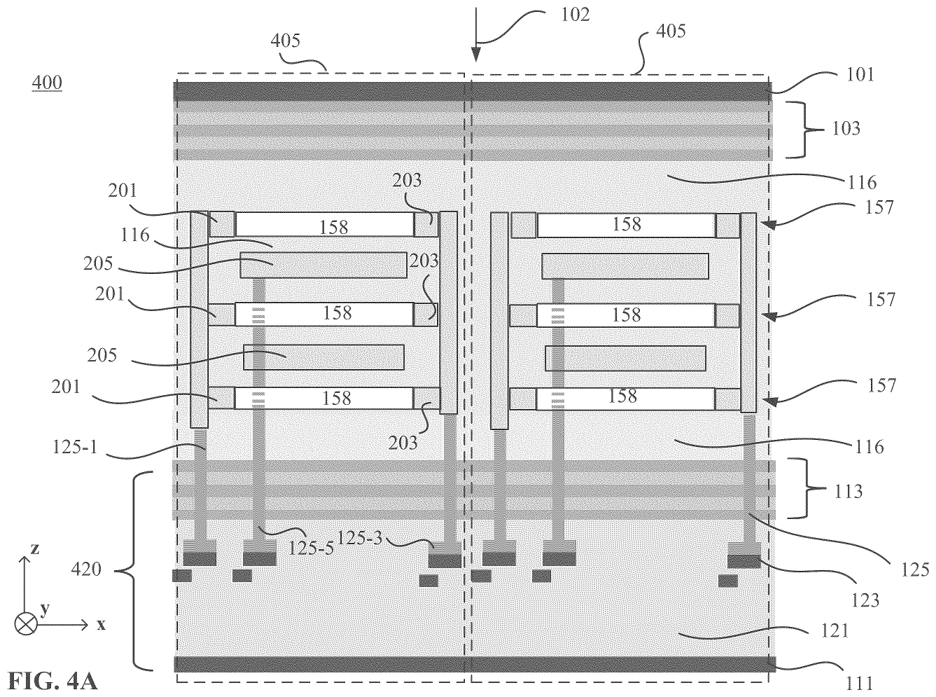

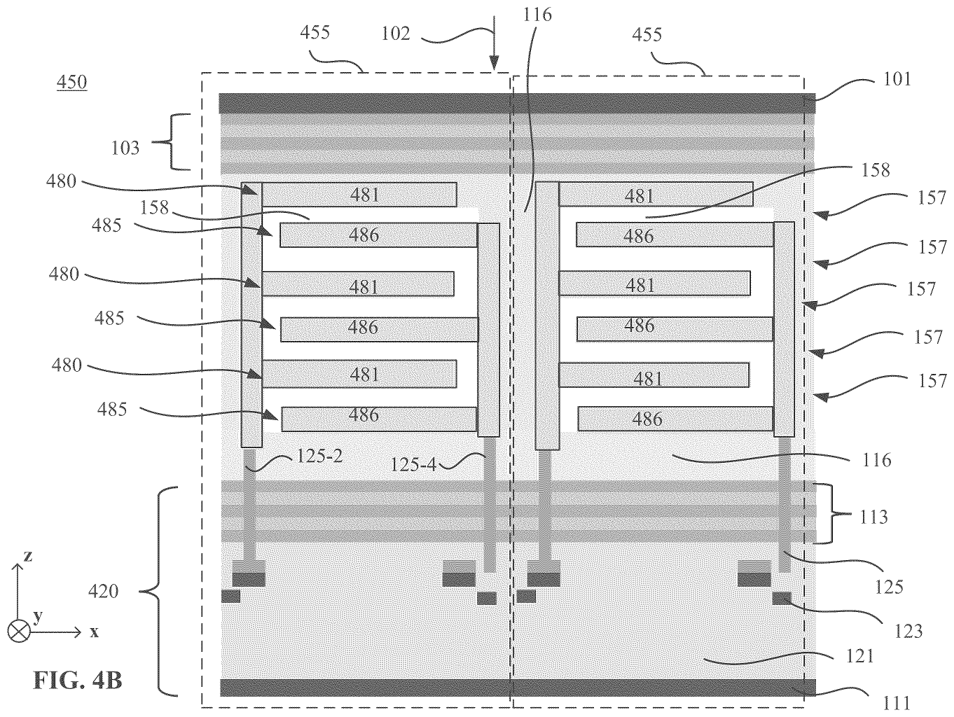

FIG. 4A illustrates an x-z sectional view of an organic solid crystal based SLM 400, according to one or more examples of the present disclosure. The SLM 400 may include structures or elements that are the same as or similar to those included in the SLM 100 shown in FIG. 1A, the SLM 150 shown in FIG. 1B, the SLM 200 shown in FIG. 2A, the SLM 230 shown in FIG. 2B, the SLM 250 shown in FIG. 2C, the SLM 270 shown in FIG. 2D, the SLM 300 shown in FIG. 3A, or the SLM 350 shown in FIG. 3B. Descriptions of the same or similar structures or elements included in the example shown in FIG. 4A can refer to the above descriptions, including those rendered in connection with the examples shown in FIG. 1A, FIG. 1B, FIG. 2A, FIG. 2B, FIG. 2C, FIG. 2D, FIG. 3A, or FIG. 3B.

As shown in FIG. 4A, the SLM 400 may include the first polarizer 101, the first coating 103, a backplane 420, and a plurality of (e.g., three) patterned organic solid crystals 157 disposed between the first coating 103 and the backplane 420 in a stacked form along the thickness direction (e.g., the z-axis direction). The backplane 420 may include the base substrate 121, the electric circuitry 123, the conducting vias 125, the second coating 113, and the second polarizer 111. One or more (e.g., each) of the patterned organic solid crystals 157 may include a plurality of organic solid crystal segments 158 arranged in an array (e.g., a 1D or 2D array) within a plane perpendicular to the thickness direction of the SLM 400. For discussion purposes, FIG. 4A shows that each patterned organic solid crystal 157 includes two organic solid crystal segments 158 disposed side by side in the lateral direction (e.g., x-axis direction). One or more (e.g., each) of the organic solid crystal segments 158 may be coupled with the source electrode (S) 201, the drain electrode (D) 203, and the gate electrode (G) 205, with the gate insulator 116 disposed between the gate electrode (G) 205 and the organic solid crystal segment 158.

The SLM 400 may include an array of pixels 405, one or more (e.g., each) of which may include a multi-layer OFET type device. For example, in FIG. 4A, the multi-layer OFET type device included in each pixel 405 may include a plurality of (e.g., three) organic solid crystal segments 158 stacked in the thickness direction of the SLM 400 and separated from one another by the insulator 116, a plurality of (e.g., three) pairs of the source electrodes (S) 201 and the drain electrodes (D) 203 respectively coupled with the organic solid crystal segment 158, and a plurality of (e.g., two) gate electrodes (G) 205 shared by the organic solid crystal segments 158.

In some examples, the plurality of (e.g., three) organic solid crystal segments 158 included in the same pixel 405 (or the same multi-layer OFET type device) may be coupled with individual source electrodes (S) 201 and individual drain electrodes (D) 203, and may share the plurality of (e.g., two) gate electrodes (G) 205. For example, FIG. 4A shows that two adjacent organic solid crystal segments 158 included in the same pixel 405 (or the same multi-layer OFET type device) may be coupled with individual source electrodes (S) 201 and individual drain electrodes (D) 203, and may share the same gate electrode (G) 205. In some examples, although not shown, the respective organic solid crystal segment 158 included in the same pixel 405 (or the same multi-layer OFET type device) may be coupled with individual gate electrodes (G) 205.

The relative positions of the source electrode (S) 201, the drain electrode (D) 203, and the gate electrode (G) 205 with respect to the organic solid crystal segment 158 shown in FIG. 4A are for illustrative purposes. The source electrode (S) 201, the drain electrode (D) 203, and the gate electrode (G) 205 may have suitable positions relative to the organic solid crystal segment 158, such as those shown in FIG. 2A-2D.

As shown in FIG. 4A, in the same pixel 405 (or the same multi-layer OFET type device), the source electrodes (S) 201 may be electrically connected to a same conducting via (referred to as a source bus line) 125-1, the drain electrodes (D) 203 may be electrically connected to a same conducting via (referred to as a drain bus line) 125-3, and the gate electrodes (G) 205 may be electrically connected to a same conducting via (referred to as a gate bus line) 125-5. Thus, the organic solid crystal segments 158 included in the same pixel 405 may be applied with the same gate-source voltage and the same drain-source voltage. Accordingly, the organic solid crystal segments 158 included in the same pixel 405 may provide the same phase retardance to the input light beam 102 propagating therethrough. The overall phase retardance provided by the pixel 405 may be a sum of the phase retardances provided by the respective organic solid crystal segments 158 included in the pixel 405.

In some examples, although not shown, the organic solid crystal segments 158 included in the same pixel 405 may be configured to provide different phase retardances to the input light beam 102 propagating there through. For example, at least the gate electrodes (G) 205 of the respective organic solid crystal segments 158 included in the same pixel 405 may be electrically connected to individually gate bus lines. Thus, the gate-source voltages applied to the organic solid crystal segments 158 included in the same pixel 405 may be individually configured.

In some examples, during an operation of the SLM 400, the drain-source voltages applied to multi-layer OFET devices in the respective pixels 405 may be substantially the same, while the gate-source voltages applied to the multi-layer OFET devices in the respective pixels 405 may be individually (or independently) configured. Thus, the refractive indices, the birefringences, and/or the absorption characteristics provided by the respective pixels 405 may be individually configurable to modulate the local amplitudes and/or local phases of the input light beam 102. In some examples, the response time of the SLM 400 may be substantially the same as a disclosed SLM including a single layer of organic solid crystal (e.g., the SLMs shown in FIGS. 2A-2D), while the overall phase retardance provided by the SLM 400 may be significantly improved.

FIG. 4B illustrates an x-z sectional view of an organic solid crystal based SLM 450, according to one or more examples of the present disclosure. The SLM 450 may include structures or elements that are the same as or similar to those included in the SLM 100 shown in FIG. 1A, the SLM 150 shown in FIG. 1B, the SLM 200 shown in FIG. 2A, the SLM 230 shown in FIG. 2B, the SLM 250 shown in FIG. 2C, the SLM 270 shown in FIG. 2D, the SLM 300 shown in FIG. 3A, the SLM 350 shown in FIG. 3B, or the SLM 400 shown in FIG. 4A. Descriptions of the same or similar structures or elements included in the example shown in FIG. 4B can refer to the above descriptions, including those rendered in connection with the example shown in FIG. 1A, FIG. 1B, FIG. 2A, FIG. 2B, FIG. 2C, FIG. 2D, FIG. 3A, FIG. 3B, or FIG. 4A.

As shown in FIG. 4B, the SLM 450 may include the first polarizer 101, the first coating 103, the backplane 420, and a plurality of (e.g., five) patterned organic solid crystals 157 disposed between the first coating 103 and the backplane 420 in a stacked configuration along the thickness direction (e.g., the z-axis direction). One or more (e.g., each) of the patterned organic solid crystals 157 may include an array of organic solid crystal segments 158 (e.g., a 1D or 2D array) arranged within a plane perpendicular to the thickness direction of the SLM 450. For example, FIG. 4B shows that each patterned organic solid crystal 157 includes a plurality of (e.g., two) organic solid crystal segments 158 disposed side by side in the lateral direction (e.g., the x-axis direction). The SLM 450 may also include a plurality of (e.g., three) patterned common electrode layers 485, and a plurality of (e.g., three) patterned pixel electrode layers 480 stacked in the thickness direction of the SLM 450, for driving the patterned organic solid crystals 157. For example, each patterned common electrode layer 485 may include a plurality of (e.g., two) common electrodes 486, and each patterned pixel electrode layer 480 may include a plurality of (e.g., two) pixel electrodes 481. The patterned common electrode layer 485 and the patterned pixel electrode layer 480 may include materials that are similar to the first electrode layer 105 and the second electrode layer 115 shown in FIGS. 1A and 1B, respectively. In some examples, each organic solid crystal segment 158 may be coupled with a common electrode 486 and a pixel electrode 481.

The SLM 450 may include an array of pixels 455, one or more (e.g., each) of which may include a multi-layer resistive type device or a multi-layer Schottky p-n junction type device. For example, in FIG. 4B, the multi-layer resistive type device or the multi-layer Schottky p-n junction type device included in each pixel 455 may include a plurality of (e.g., five) organic solid crystal segments 158, a plurality of (e.g., three) common electrodes 486, and a plurality of (e.g., three) pixel electrodes 481 alternately arranged in the thickness direction of the SLM 450. In some examples, the plurality of (e.g., five) organic solid crystal segment 158 included in the same pixel 455 may be coupled with individual pixel electrodes 481, while sharing the plurality of (e.g., three) common electrodes 486. For example, FIG. 4B shows that two adjacent organic solid crystal segments 158 included in the same pixel 455 may be coupled with individual pixel electrodes 481, and with the same common electrode 486. In some examples, although not shown, the plurality of organic solid crystal segments 158 included in the same pixel 405 may be coupled with individual common electrodes 486.

As shown in FIG. 4B, in the same pixel 455, the plurality of (e.g., three) common electrodes 486 may be electrically connected to a same conducting via (referred to as a common bus line) 125-4, and the plurality of (e.g., three) pixel electrodes 481 may be electrically connected to a same conducting via (referred to as a pixel bus line) 125-2. Thus, the organic solid crystal segments 158 included in the same pixel 455 may be applied with the same common voltage and the same pixel voltage. Accordingly, the organic solid crystal segments 158 included in the same pixel 455 may be controlled to provide the same phase retardance to the input light beam 102 propagating therethrough. The overall phase retardance provided by the pixel 455 may be a sum of the phase retardances provided by the respective organic solid crystal segments 158.

Although not shown, the organic solid crystal segments 158 included in the same pixel 455 may be controlled to provide different phase retardances to the input light beam 102 propagating therethrough. For example, the pixel electrodes 481 coupled with the organic solid crystal segments 158 in the same pixel 455 may be electrically connected to individually pixel bus lines. Thus, the pixel voltages applied to the organic solid crystal segments 158 included in the same pixel 455 may be individually configured.

In some examples, during an operation of the SLM 450, the common voltage applied to the respective pixels 455 may be substantially the same, while the pixel voltages applied to the respective pixels 455 may be individually (or independently) configured. Thus, the refractive indices, the birefringences, and/or the absorption characteristics provided by the respective pixels 455 may be individually configurable to modulate the local amplitudes and/or local phases of the input light beam 102. In some examples, the response time of the SLM 450 may be substantially the same as a disclosed SLM including a single layer of organic solid crystal (e.g., the SLMs shown in FIGS. 1A and 1B), while the overall phase retardance provided by the SLM 450 may be significantly improved.

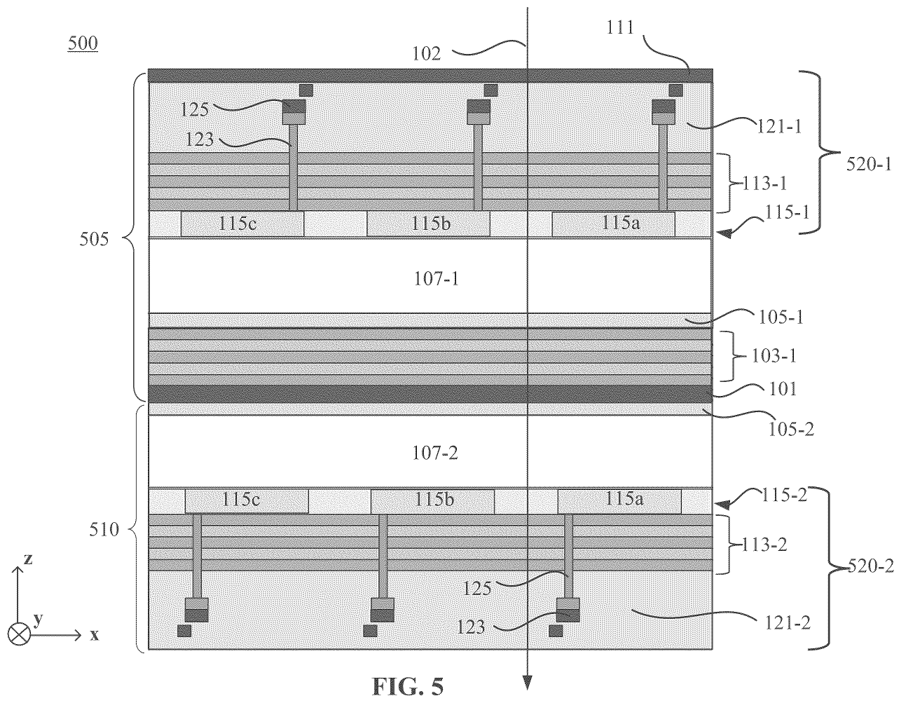

FIG. 5 illustrates an x-z sectional view of an organic solid crystal based SLM 500, according to one or more examples of the present disclosure. The SLM 500 may include structures or elements that are the same as or similar to those included in the SLM 100 shown in FIG. 1A, the SLM 150 shown in FIG. 1B, the SLM 200 shown in FIG. 2A, the SLM 230 shown in FIG. 2B, the SLM 250 shown in FIG. 2C, the SLM 270 shown in FIG. 2D, the SLM 300 shown in FIG. 3A, the SLM 350 shown in FIG. 3B, the SLM 400 shown in FIG. 4A, or the SLM 450 shown in FIG. 4B. Descriptions of the same or similar structures or elements included in the example shown in FIG. 5 can refer to the above descriptions, including those rendered in connection with the example shown in FIG. 1A, FIG. 1B, FIG. 2A, FIG. 2B, FIG. 2C, FIG. 2D, FIG. 3A, FIG. 3B, FIG. 4A, or FIG. 4B.

The SLM 500 may be a complex field (or complex wavefront) modulator configured to provide spatially varying modulations of multiple DOFs of the input light beam 102. For discussion purposes, the SLM 500 is shown as providing spatially varying modulations of the amplitude and the phase of the input light beam 102. The disclosed design principles may be applied to any suitable solid crystal based complex wavefront modulators that provide spatially varying modulations of multiple DOFs of the input light beam 102. The DOFs of the input light beam 102 may include the amplitude, the phase, the polarization, etc., or a combination thereof.

As shown in FIG. 5, the SLM 500 may include a first cell 505 and a second cell 510 arranged in a stacked configuration. The first cell 505 and the second cell 510 may be configured to modulate two different DOFs of the input light beam 102, e.g., modulating an amplitude and a phase of the input light beam 102, respectively. One or both of the first cell 505 and the second cell 510 may be an example of the SLM disclosed herein, such as the SLM 100 shown in FIG. 1A, the SLM 150 shown in FIG. 1B, the SLM 200 shown in FIG. 2A, the SLM 230 shown in FIG. 2B, the SLM 250 shown in FIG. 2C, the SLM 270 shown in FIG. 2D, the SLM 300 shown in FIG. 3A, the SLM 350 shown in FIG. 3B, the SLM 400 shown in FIG. 4A, or the SLM 450 shown in FIG. 4B.

For illustrative purposes, the first cell 505 and the second cell 510 in FIG. 5 are shown as having structures similar to the SLM 100 shown in FIG. 1A. For example, the first cell 505 may include the first polarizer 101, a first coating 103-1, a first electrode layer (e.g., a common electrode layer) 105-1, an organic solid crystal 107-1, and a backplane 520-1. The backplane 520-1 may include a base substrate 121-1, the electric circuitry 123, the conducting vias 125, a second electrode layer (e.g., a pixel electrode layer) 115-1, a second coating 113-1, and the second polarizer 111. The second cell 510 may include a first electrode layer (e.g., a common electrode layer) 105-2, an organic solid crystal 107-2, and a backplane 520-2. The backplane 520-2 may include a base substrate 121-2, the electric circuitry 123, the conducting vias 125, a second coating 113-2, and a second electrode layer (e.g., a pixel electrode layer) 115-2. For illustrative purposes, FIG. 5 shows that the first cell 505 provides spatially varying modulations of the amplitude of the input light beam 102, and the second cell 510 provides spatially varying modulations of the phase of the input light beam 102.

The SLM 500 may be fabricated by monolithic growth. For example, the backplane 520-1 and the backplane 520-2 may be fabricated via suitable fabrication techniques. The organic solid crystal 107-1 may be fabricated (e.g., grown) on the backplane 520-1, e.g., on the second electrode layer 115-1 in the backplane 520-1. The first electrode layer 105-1, the first coating 103-1, the first polarizer 101, and the first electrode layer 105-2 may be successively fabricated on the organic solid crystal 107-1. Then the organic solid crystal 107-2 may be fabricated (e.g., grown) on the first electrode layer 105-2, and the backplane 520-2 may be disposed at the organic solid crystal 107-2, and aligned with the backplane 520-1.

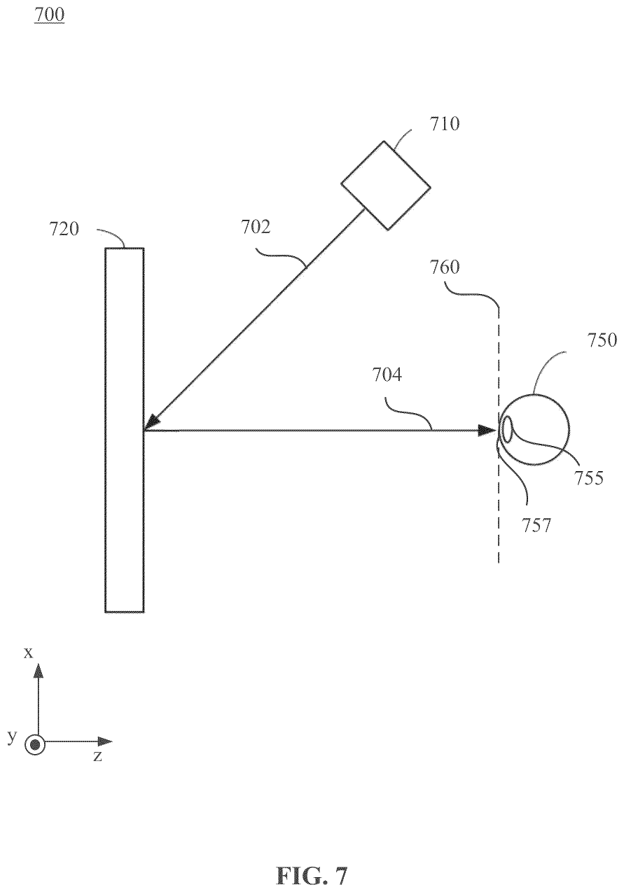

FIG. 7 to FIG. 9 illustrate various optical system configurations that include one or more organic solid crystal based SLMs disclosed herein, according to various examples of the present disclosure. Such optical systems may be implemented in various devices or systems, e.g., head-up displays (“HUDs”), head-mounted displays (“HMDs”), near-eye displays (“NEDs”), smart phones, laptops, televisions, vehicles, etc., for virtual reality (“VR”), augmented reality (“AR”), and/or mixed reality (“MR”) applications. For example, the SLM disclosed herein may be configured to modulate a light beam emitted by a light source into a light beam representing a virtual image, e.g., a hologram. For modulating the light beam emitted by a light source into a light beam representing a full color virtual image, a single SLM disclosed herein may include a plurality of pixels configured to modulate light beams of different wavelength ranges, e.g., red pixels for modulating red light, green pixels for modulating green light, and blue pixels for modulating blue light. In some examples, a plurality of SLMs configured to modulate light beams of different wavelength ranges may be stacked, e.g., a first SLM including red pixels for modulating red light, a second SLM including green pixels for modulating green light, and a third SLM including blue pixels for modulating blue light. The pixels included in an SLM disclosed herein may be configured to have different switching speeds for different wavelength ranges (e.g., red wavelength range, green wavelength range, and blue wavelength range), enabling field sequential display applications. In some examples, an SLM disclosed herein may be configured to provide a 2*π phase modulation range (or phase shift) for an input light beam and a refresh rate that is greater than 6 kHz, enabling light field display applications.

The optical systems shown in FIG. 7 to FIG. 9 are for illustrative purposes, and the organic solid crystal based SLMs disclosed herein may generally be included in any suitable optical systems. FIG. 7 illustrates a schematic diagram of an optical system 700, according to one or more examples of the present disclosure. For example, the optical system 700 may be included in a virtual reality NED. As shown in FIG. 7, the optical system 700 may include a light source 710, and one or more organic solid crystal based SLMs 720. For illustrative purposes, the optical system 700 is shown as including a single SLM 720. The organic solid crystal based SLM 720 may be an example of the organic solid crystal based SLM disclosed herein, such as the SLM 100 shown in FIG. 1A, the SLM 150 shown in FIG. 1B, the SLM 200 shown in FIG. 2A, the SLM 230 shown in FIG. 2B, the SLM 250 shown in FIG. 2C, the SLM 270 shown in FIG. 2D, the SLM 300 shown in FIG. 3A, the SLM 350 shown in FIG. 3B, the SLM 400 shown in FIG. 4A, the SLM 450 shown in FIG. 4B, or the SLM 500 shown in FIG. 5.

The light source 710 may be configured to project a light beam 702 onto the organic solid crystal based SLM 720. The light source 710 may include a coherent light source, such as a light-emitting diode (“LED”), a micro light-emitting diode (“micro-LED”), a superluminescent LED, or a combination thereof, etc. The organic solid crystal based SLM 720 may be a reflective SLM. The organic solid crystal based SLM 720 may be configured to modulate the light beam 702 emitted by the light source 710 into a light beam 704. The light beam 704 may represent a virtual image, e.g., a hologram. The organic solid crystal based SLM 720 may be used in other suitable applications, such as video or image projection.

In some examples, the optical system 700 may also include additional components that are not shown in FIG. 7. For example, the optical system 700 may include a lens assembly configured to focus the light beam 704 modulated by the organic solid crystal based SLM 720 to one or more exit pupils 757 in an eye-box region 760. The exit pupil 757 may be a location where an eye pupil 755 of the eye 750 may be positioned in the eye-box region 760 of the system 700. Thus, the eye 750 located at the exit pupil 757 may perceive the hologram generated by the organic solid crystal based SLM 720. In some examples, the optical system 700 may also include an eye tracking module configured to provide eye position information to a controller, and a pupil-steering assembly configured to steer the exit pupil 757 to different locations according to an eye gaze angle, etc.

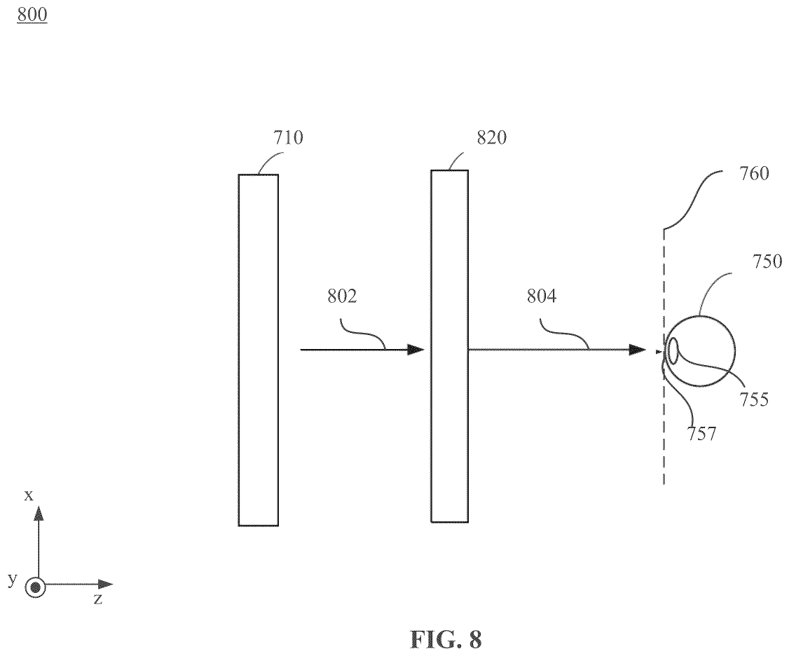

FIG. 8 illustrates a schematic diagram of an optical system 800 including a disclosed organic solid crystal based SLM, according to one or more examples of the present disclosure. For example, the optical system 800 may be included in a virtual reality NED. As shown in FIG. 8, the optical system 800 may include the light source 710, and one or more organic solid crystal based SLMs 820. For illustrative purposes, the optical system 800 is shown as including a single SLM 820. The organic solid crystal based SLM 820 may be an example of the organic solid crystal based SLM disclosed herein, such as the SLM 100 shown in FIG. 1A, the SLM 150 shown in FIG. 1B, the SLM 200 shown in FIG. 2A, the SLM 230 shown in FIG. 2B, the SLM 250 shown in FIG. 2C, the SLM 270 shown in FIG. 2D, the SLM 300 shown in FIG. 3A, the SLM 350 shown in FIG. 3B, the SLM 400 shown in FIG. 4A, the SLM 450 shown in FIG. 4B, or the SLM 500 shown in FIG. 5.

As shown in FIG. 8, the light source 710 may be configured to project a light beam 802 onto the organic solid crystal based SLM 820. In the configuration shown in FIG. 8, the organic solid crystal based SLM 820 may be a transmissive SLM. The organic solid crystal based SLM 820 may be configured to modulate the light beam 802 emitted by the light source 710 into a light beam 804. The light beam 804 may represent a virtual image, e.g., a hologram. The organic solid crystal based SLM 820 may be used in other suitable applications, such as video or image projection.

In some examples, the optical system 800 may also include additional components that are not shown in FIG. 8. For example, the optical system 800 may include a lens assembly configured to focus the light beam 804 modulated by the organic solid crystal based SLM 820 to one or more exit pupils 757 in the eye-box region 760. Thus, the eye 750 located at the exit pupil 757 may perceive the hologram generated by the organic solid crystal based SLM 820. In some examples, the optical system 800 may also include an eye tracking device configured to provide eye position information to a controller, and a pupil-steering assembly configured to steer the exit pupil 757 to different locations according to an eye gaze angle, etc.

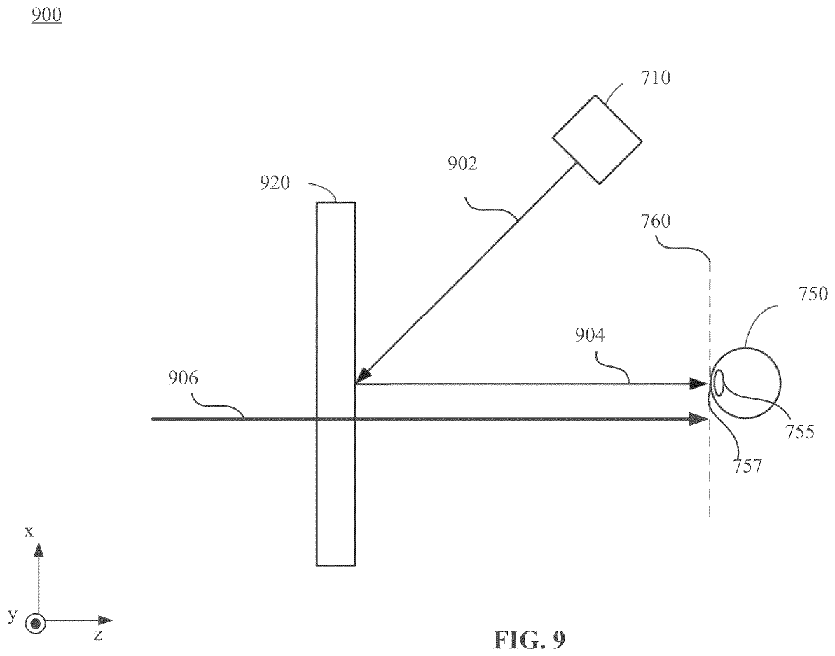

FIG. 9 illustrates a schematic diagram of an optical system 900 including a disclosed organic solid crystal based SLM, according to one or more examples of the present disclosure. For example, the optical system 900 may be included in an augmented reality NED or a mixed reality NED. As shown in FIG. 9, the optical system 900 may include the light source 710, and one or more organic solid crystal based SLMs 920. For illustrative purposes, the optical system 900 is shown as including a single SLM 920. The organic solid crystal based SLM 920 may be an example of the organic solid crystal based SLM disclosed herein, such as the SLM 100 shown in FIG. 1A, the SLM 150 shown in FIG. 1B, the SLM 200 shown in FIG. 2A, the SLM 230 shown in FIG. 2B, the SLM 250 shown in FIG. 2C, the SLM 270 shown in FIG. 2D, the SLM 300 shown in FIG. 3A, the SLM 350 shown in FIG. 3B, the SLM 400 shown in FIG. 4A, the SLM 450 shown in FIG. 4B, or the SLM 500 shown in FIG. 5.

As shown in FIG. 9, the light source 710 may be configured to project a light beam 902 onto the organic solid crystal based SLM 920. The organic solid crystal based SLM 920 may be a transflective SLM. For example, the organic solid crystal based SLM 920 may modulate the light beam 902, and partially reflect the light beam 902 into a light beam 904 propagating toward the eye-box region 760. The light beam 904 may represent a virtual image, e.g., a hologram. In addition, the organic solid crystal based SLM 920 may transmit a light 906 from a real world environment (referred to as a real world light 906) toward the eye-box region 760. The organic solid crystal based SLM 920 may not modulate the real world light 906. Thus, the eye 750 may perceive optically combined virtual scene and real world scene.

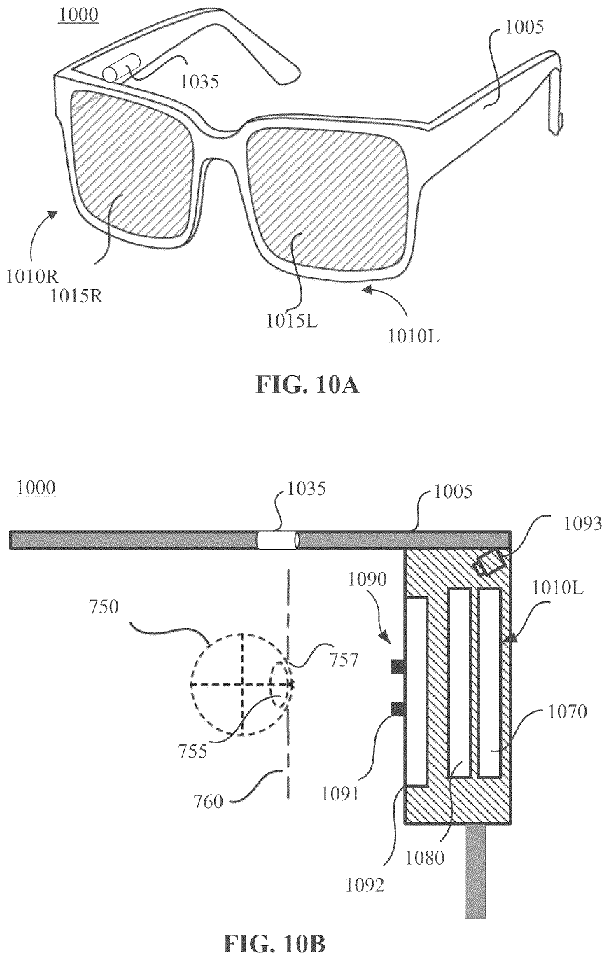

FIG. 10A illustrates a schematic diagram of an artificial reality device 1000 according to one or more examples of the present disclosure. The artificial reality device 1000 may produce VR, AR, and/or MR content for a user, such as images, video, audio, or a combination thereof. In some examples, the artificial reality device 1000 may be smart glasses. In one example, the artificial reality device 1000 may be a near-eye display (“NED”). In some examples, the artificial reality device 1000 may be in the form of eye glasses, goggles, a helmet, a visor, or some other type of eyewear. In some examples, the artificial reality device 1000 may be configured to be worn on a head of a user (e.g., by having the form of spectacles or eye glasses, as shown in FIG. 10A), or to be included as part of a helmet that is worn by the user. In some examples, the artificial reality device 1000 may be configured for placement in proximity to an eye or eyes of the user at a fixed location in front of the eye(s), without being mounted to the head of the user. In some examples, the artificial reality device 1000 may be in a form of eye glasses which provide vision correction to a user's eyesight. In some examples, the artificial reality device 1000 may be in a form of sun glasses which protect the eyes of the user from the bright sunlight. In some examples, the artificial reality device 1000 may be in a form of safety glasses which protect the eyes of the user. In some examples, the artificial reality device 1000 may be in a form of a night vision device or infrared goggles to enhance a user's vision at night.

For discussion purposes, FIG. 10A shows that the artificial reality device 1000 includes a frame 1005 configured to mount to a head of a user, and a left-eye display system 1010L and a right-eye display system 1010R mounted to the frame 1005. FIG. 10B is a cross-sectional view of half of the artificial reality device 1000 shown in FIG. 10A according to one or more examples of the present disclosure. For illustrative purposes, FIG. 10B shows the cross-sectional view associated with the left-eye display system 1010L. The frame 1005 is merely an example structure to which various components of the artificial reality device 1000 may be mounted. Other suitable type of fixtures may be used in place of or in combination with the frame 1005.

In some examples, one or both of the left-eye display system 1010L and the right-eye display system 1010R may include suitable image display components configured to generate virtual images. In some examples, one or more (e.g., each) of the left-eye display system 1010L and the right-eye display system 1010R may include a light source 1035, and one or more SLMs 1070. The SLM 1070 may be any organic solid crystal based SLM disclosed herein, such as the SLM 100 shown in FIG. 1A, the SLM 150 shown in FIG. 1B, the SLM 200 shown in FIG. 2A, the SLM 230 shown in FIG. 2B, the SLM 250 shown in FIG. 2C, the SLM 270 shown in FIG. 2D, the SLM 300 shown in FIG. 3A, the SLM 350 shown in FIG. 3B, the SLM 400 shown in FIG. 4A, the SLM 450 shown in FIG. 4B, or the SLM 500 shown in FIG. 5. For illustrative purposes, FIG. 10B shows that the left-eye display system 1010L includes a single SLM 1070.

For illustrative purposes, FIG. 10A shows that the left-eye display systems 1010L may include the light source 1035 (e.g., similar to the light source 710 shown in FIG. 7 to FIG. 9) coupled to the frame 1005. The light source 1035 may project a light beam onto the SLM 1070. The SLM 1070 may modulate the light beam emitted by the light source 1035 into an image light beam representing a virtual image, e.g., a hologram.

In some examples, as shown in FIG. 10B, the artificial reality device 1000 may also include a viewing optical system 1080 and an object tracking system 1090 (e.g., eye tracking system and/or face tracking system). The viewing optical system 1080 may be configured to guide the image light output from the SLM 1070 to the exit pupil 757. The exit pupil 757 may be a location where the eye pupil 755 of the eye 750 of the user may be positioned in the eye-box region 760 of the artificial reality device 1000. In some examples, the eye-box region 760 may be a full eye-box region. In some examples, the eye-box region 760 may be an active eye-box. For example, the viewing optical system 1080 may include one or more optical elements configured to, e.g., correct aberrations in an image light output from the left-eye display system 1010L, focus the image light output from the left-eye display system 1010L, and/or steer a focal point of the image light output from the left-eye display system 1010L, etc.

The object tracking system 1090 may include an IR light source 1091 configured to illuminate the eye 750 and/or the face, a deflecting element 1092 (such as a grating), and an optical sensor 1093 (such as a camera). The deflecting element 1092 may deflect (e.g., diffract) the IR light reflected by the eye 750 toward the optical sensor 1093. The optical sensor 1093 may generate a tracking signal relating to the eye 750. The tracking signal may be an image of the eye 750. A controller (not shown) may control various optical elements, such as an active in-coupling element, an active out-coupling element, an active dimming element, etc., based on eye-tracking information obtained from analysis of the image of the eye 750.

In some examples, the artificial reality device 1000 may include an adaptive or active dimming device (not shown) configured to dynamically adjust the transmittance of lights reflected by real-world objects, thereby switching the artificial reality device 1000 between a VR device and an AR device or between a VR device and an MR device. In some examples, along with switching between the AR/MR device and the VR device, the adaptive dimming element may be used in the AR and/MR device to mitigate differences in brightness of lights reflected by real-world objects and virtual image lights.

The present disclosure provides a device. The device may include an organic solid crystal, and a pixel electrode layer and a common electrode layer coupled with the organic solid crystal. The pixel electrode layer may include an array of pixel electrodes. The device may also include a controller configured to individually configure voltages applied to the pixel electrodes to individually configure local refractive indices of the organic solid crystal.

In some examples, the device may also include an array of pixels configured to provide spatially varying modulations of one or more degrees of freedom of an input light beam. A pixel in the array of the pixels may include a corresponding portion of the organic solid crystal, a corresponding portion of the pixel electrode layer, and a corresponding portion of the common electrode layer. In some examples, the common electrode layer and the pixel electrode layer may be in direct contact with the organic solid crystal.

In some examples, the device may also include at least one of a first spacing layer disposed between the common electrode layer and the organic solid crystal, or a second spacing layer disposed between the pixel electrode layer and the organic solid crystal. In some examples, the common electrode layer and the pixel electrode layer may be disposed at a same side of the organic solid crystal, and the device may also include an electrically insulating layer disposed between the common electrode layer and the pixel electrode layer.

In some examples, the organic solid crystal may be a contiguous organic solid crystal. In some examples, the organic solid crystal may be a patterned organic solid crystal including an array of solid crystal segments corresponding to the array of pixel electrodes. In some examples, the organic solid crystal may be a first patterned organic solid crystal including an array of first solid crystal segments, and the pixel electrode layer may be a first pixel electrode layer including an array of first pixel electrodes. The device may also include a second patterned organic solid crystal including an array of second solid crystal segments and stacked with the first patterned organic solid crystal in a thickness direction of the device; and a second pixel electrode layer coupled with the second patterned organic solid crystal and including an array of second pixel electrodes.

In some examples, the device may also include a plurality of pixels. A pixel in the plurality of pixels may include a first solid crystal segment and a second solid crystal segment arranged along the thickness direction of the device, a first pixel electrode coupled with the first solid crystal segment, and a second pixel electrode coupled with the second solid crystal segment. In some examples, the first pixel electrode and second pixel electrode included in the pixel may be electrically connected to a same pixel bus line. In some examples, the first solid crystal segment and the second solid crystal segment included in the pixel may share the common electrode layer.

In some examples, the present disclosure provides a device. The device may include one or more patterned organic solid crystals arranged in a thickness direction of the device. A patterned organic solid crystal of the one or more patterned organic solid crystals may include an array of solid crystal segments arranged within a plane perpendicular to the thickness direction of the device. A solid crystal segment of the array of solid crystal segments may be coupled with a source electrode, a drain electrode, a gate electrode, and an insulator disposed between the gate electrode and the solid crystal segment. The device may also include a controller configured to individually configure voltages applied to the solid crystal segments to individually configure refractive indices of the solid crystal segments.

In some examples, the insulator may also be disposed between adjacent solid crystal segments included in a same patterned organic solid crystal, and between adjacent patterned organic solid crystals arranged in a thickness direction of the device. In some examples, the gate electrode may be a reflective electrode or a transmissive electrode.

In some examples, the solid crystal segment may include a first side and an opposing second side arranged along a thickness direction of the solid crystal segment, a third side and an opposing fourth side arranged along a lateral direction of the solid crystal segment. The gate electrode may be disposed at the first side or the second side of the solid crystal segment, and the source electrode and the drain electrode may be disposed at the third side and the fourth side of the solid crystal segment.

In some examples, the solid crystal segment may include a first side and an opposing second side arranged along a thickness direction of the solid crystal segment. The gate electrode, the source electrode, and the drain electrode may be disposed at the first side or the second side of the solid crystal segment.

In some examples, the solid crystal segment may include a first side and an opposing second side arranged along a thickness direction of the solid crystal segment, a third side and an opposing fourth side arranged along a lateral direction of the solid crystal segment. The gate electrode may be disposed at the first side or the second side of the solid crystal segment, and the source electrode and the drain electrode may be at least partially disposed inside the solid crystal segment.

In some examples, the solid crystal segment may include a first side and an opposing second side arranged along a thickness direction of the solid crystal segment, the gate electrode may be disposed at the first side of the solid crystal segment, and the source electrode and the drain electrode may be disposed at the second side of the solid crystal segment.

In some examples, the solid crystal segments in a same patterned organic solid crystal may be separated from one another by the insulator, and two or more patterned organic solid crystals arranged in a thickness direction of the device may be separated from one another by the insulator.

In some examples, the device may also include a plurality of pixels configured to provide spatially varying modulations of one or more degrees of freedom of an input light beam. A pixel of the plurality of pixels may include corresponding solid crystal segments of the one or more patterned organic solid crystals arranged along the thickness direction of the device. In the pixel, two adjacent solid crystal segments arranged along the thickness direction of the device included in a same pixel may be coupled with individual source electrodes, individual drain electrodes, and a same gate electrode.

In some examples, the device may also include a plurality of pixels configured to provide spatially varying modulations of one or more degrees of freedom of an input light beam. A pixel of the plurality of pixels may include three or more solid crystal segments arranged along the thickness direction of the device. In the pixel, the three or more solid crystal segments may be coupled with individual source electrodes that are electrically connected to a same source bus line, coupled with individual drain electrodes that are electrically connected to a same drain bus line, and coupled with a plurality of gate electrodes that are electrically connected to a same gate bus line.

Any of the steps, operations, or processes described herein may be performed or implemented with one or more hardware and/or software modules, alone or in combination with other devices. A software module may be implemented with a computer program product including a computer-readable medium containing computer program code, which can be executed by a computer processor for performing any or all of the steps, operations, or processes described. In some embodiments, a hardware module may include hardware components such as a device, a system, an optical element, a controller, an electrical circuit, a logic gate, etc.

Embodiments of the disclosure may also relate to an apparatus for performing the operations herein. This apparatus may be specially constructed for the specific purposes, and/or it may include a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. The non-transitory computer-readable storage medium can be any medium that can store program codes, for example, a magnetic disk, an optical disk, a read-only memory (“ROM”), or a random access memory (“RAM”), an Electrically Programmable read only memory (“EPROM”), an Electrically Erasable Programmable read only memory (“EEPROM”), a register, a hard disk, a solid-state disk drive, a smart media card (“SMC”), a secure digital card (“SD”), a flash card, etc. Furthermore, any computing systems described in the specification may include a single processor or may be architectures employing multiple processors for increased computing capability. The processor may be a central processing unit (“CPU”), a graphics processing unit (“GPU”), or any processing device configured to process data and/or performing computation based on data. The processor may include both software and hardware components. For example, the processor may include a hardware component, such as an application-specific integrated circuit (“ASIC”), a programmable logic device (“PLD”), or a combination thereof. The PLD may be a complex programmable logic device (“CPLD”), a field-programmable gate array (“FPGA”), etc.

Further, when an embodiment illustrated in a drawing shows a single element, it is understood that the embodiment may include a plurality of such elements. Likewise, when an embodiment illustrated in a drawing shows a plurality of such elements, it is understood that the embodiment may include only one such element. The number of elements illustrated in the drawing is for illustration purposes only, and should not be construed as limiting the scope of the embodiment. Moreover, unless otherwise noted, the embodiments shown in the drawings are not mutually exclusive, and they may be combined in any suitable manner. For example, elements shown in one embodiment but not another embodiment may nevertheless be included in the other embodiment.

Various embodiments have been described to illustrate the exemplary implementations. Based on the disclosed embodiments, a person having ordinary skills in the art may make various other changes, modifications, rearrangements, and substitutions without departing from the scope of the present disclosure. Thus, while the present disclosure has been described in detail with reference to the above embodiments, the present disclosure is not limited to the above described embodiments. The present disclosure may be embodied in other equivalent forms without departing from the scope of the present disclosure. The scope of the present disclosure is defined in the appended claims.

What is claimed is:

1. A device, comprising:
an organic solid crystal;
a pixel electrode layer and a common electrode layer coupled with the organic solid crystal, the pixel electrode layer including an array of pixel electrodes; and
a controller configured to individually configure voltages applied to the pixel electrodes to individually configure local refractive indices of the organic solid crystal.

2. The device of claim 1, further comprising an array of pixels configured to provide spatially varying modulations of one or more degree of freedom of an input light beam, wherein a pixel in the array of the pixels includes a corresponding portion of the organic solid crystal, a corresponding portion of the pixel electrode layer, and a corresponding portion of the common electrode layer.

3. The device of claim 1, wherein the common electrode layer and the pixel electrode layer are in direct contact with the organic solid crystal.

4. The device of claim 1, further comprising:
at least one of a first spacing layer disposed between the common electrode layer and the organic solid crystal, or a second spacing layer disposed between the pixel electrode layer and the organic solid crystal.

5. The device of claim 4, wherein the common electrode layer and the pixel electrode layer are disposed at a same side of the organic solid crystal, and the device further comprises an electrically insulating layer disposed between the common electrode layer and the pixel electrode layer.

6. The device of claim 1, wherein the organic solid crystal is a contiguous organic solid crystal.

7. The device of claim 1, wherein the organic solid crystal is a patterned organic solid crystal including an array of solid crystal segments corresponding to the array of pixel electrodes.

8. The device of claim 7, wherein the organic solid crystal is a first patterned organic solid crystal including an array of first solid crystal segments, and the pixel electrode layer is a first pixel electrode layer including an array of first pixel electrodes, the device further comprises:
a second patterned organic solid crystal including an array of second solid crystal segments and stacked with the first patterned organic solid crystal in a thickness direction of the device; and
a second pixel electrode layer coupled with the second patterned organic solid crystal and including an array of second pixel electrodes.

9. The device of claim 8, further comprising:
a plurality of pixels, wherein a pixel in the plurality of the pixels includes a first solid crystal segment and a second solid crystal segment arranged along the thickness direction of the device, a first pixel electrode coupled with the first solid crystal segment, and a second pixel electrode coupled with the second solid crystal segment.

10. The device of claim 9, wherein the first pixel electrode and the second pixel electrode included in the pixel are electrically connected to a same pixel bus line.

11. The device of claim 9, wherein the first solid crystal segment and the second solid crystal segment included in the pixel share the common electrode layer.

12. A device, comprising:
one or more patterned organic solid crystals arranged in a thickness direction of the device, wherein a patterned organic solid crystal of the one or more patterned organic solid crystals includes an array of solid crystal segments arranged within a plane perpendicular to the thickness direction of the device, and wherein a solid crystal segment of the array of solid crystal segments is coupled with a source electrode, a drain electrode, a gate electrode, and an insulator disposed between the gate electrode and the solid crystal segment; and
a controller configured to individually configure voltages applied to the solid crystal segments to individually configure refractive indices of the solid crystal segments.

13. The device of claim 12, wherein the insulator is also disposed between adjacent solid crystal segments included in a same patterned organic solid crystal, and between adjacent patterned organic solid crystals arranged in a thickness direction of the device.

14. The device of claim 12, wherein the gate electrode is a reflective electrode or a transmissive electrode.

15. The device of claim 12, wherein
the solid crystal segment includes a first side and an opposing second side arranged along a thickness direction of the solid crystal segment, a third side and an opposing fourth side arranged along a lateral direction of the solid crystal segment,
the gate electrode is disposed at the first side or the second side of the solid crystal segment, and
the source electrode and the drain electrode are disposed at the third side and the fourth side of the solid crystal segment.

16. The device of claim 12, wherein
the solid crystal segment includes a first side and an opposing second side arranged along a thickness direction of the solid crystal segment, and
the gate electrode, the source electrode, and the drain electrode are disposed at the first side or the second side of the solid crystal segment.

17. The device of claim 12, wherein
the solid crystal segment includes a first side and an opposing second side arranged along a thickness direction of the solid crystal segment, a third side and an opposing fourth side arranged along a lateral direction of the solid crystal segment,
the gate electrode is disposed at the first side or the second side of the solid crystal segment, and
the source electrode and the drain electrode are at least partially disposed inside the solid crystal segment.

18. The device of claim 12, wherein
the solid crystal segment includes a first side and an opposing second side arranged along a thickness direction of the solid crystal segment,
the gate electrode is disposed at the first side of the solid crystal segment, and
the source electrode and the drain electrode are disposed at the second side of the solid crystal segment.

19. The device of claim 12, further comprising a plurality of pixels configured to provide spatially varying modulations of one or more degrees of freedom of an input light beam,
wherein a pixel of the plurality of the pixels includes corresponding solid crystal segments of the one or more patterned organic solid crystals arranged along the thickness direction of the device, and
wherein, in the pixel, two adjacent solid crystal segments arranged along the thickness direction of the device are coupled with individual source electrodes, individual drain electrodes, and a same gate electrode.

20. The device of claim 12, further comprising a plurality of pixels configured to provide spatially varying modulations of one or more degrees of freedom of an input light beam,
wherein a pixel of the plurality of the plurality of pixels includes three or more solid crystal segments arranged along the thickness direction of the device, and
wherein in the pixel, the three or more solid crystal segments are coupled with individual source electrodes that are electrically connected to a same source bus line, coupled with individual drain electrodes that are electrically connected to a same drain bus line, and coupled with a plurality of gate electrodes that are electrically connected to a same gate bus line.
